(19) United States
(12) Patent Application Publication
(10) Pub. No.: US 2023/0358629 A1
(43) Pub. Date: Nov. 9, 2023

(54) SYSTEM FOR DETECTING OPENING OF A DOOR IN A PRESSURIZED HOSPITAL ROOM BY ANALYZING DISTURBANCE IN THE AIR PRESSURE OF THE ROOM

(71) Applicants: David Louis Kirschman, Dayton, OH (US); Gregory Carroll, Springboro, OH (US)

(72) Inventors: David Louis Kirschman, Dayton, OH (US); Gregory Carroll, Springboro, OH (US)

(73) Assignee: Aerobiotix, LLC, Miamisburg, OH (US)

(21) Appl. No.: 18/160,031

(22) Filed: Jan. 26, 2023

Related U.S. Application Data
(60) Provisional application No. 63/337,809, filed on May 3, 2022.

(51) Int. Cl. G01L 23/08

(52) U.S. Cl. CPC G01L 23/08

(57) ABSTRACT

A system for detecting the opening of a door to a pressurized room, such as a hospital operating room. A pressure sensor within the room produces a historical record of barometric pressures at the sensor=s location. The opening of the door produces a characteristic variation in the barometric pressure. The invention searches through the record, looking for the characteristic variation. When it is found, the invention issues a door-open signal.

### CROSS-REFERENCE TO RELATED APPLICATION

The present application claims priority to provisional U.S. Application Serial No. 63/337,809 filed May 3, 2022, to which Applicant claims the benefit of the filing date of this provisional application, which is incorporated herein by reference and made a part hereof.

### BACKGROUND OF THE INVENTION

### 1. Field of the Invention

This invention relates to a door opening tracking system and method and, more particularly, to a system and method that utilizes at least one pressure sensor for automatically detecting and counting door openings in a predetermined area, such as an operating room of a hospital.

### 2. Description of the Related Art

Understanding factors that lead to compromised air quality in hospital settings and improving surgical safety is an ongoing challenge of high importance. Operating room air quality is a major factor that can contribute to surgical site infections (SSI). A variety of risk factors affect the contamination level of the air in an operating room including types of medical procedures performed, occupancy levels and foot traffic. A number of controls have been designed and are being improved upon to help operating rooms maintain clean air including filtered air changes, laminar air flow, UV germicidal lamps, portable negative pressure units containing HEPA and carbon filters, and monitoring systems. Building design considerations also play a role including placing the operating theatre in an area that is progressively less contaminated relative to the reception area.

Additionally, operating rooms are typically under positive pressure as a preventive measure to inhibit the entrance of contaminants from less sterile areas to more sterile areas. An operating room under positive pressure has a higher barometric pressure than adjacent rooms and corridors, resulting in outward air flow from the operating room to the surrounding areas. Door opening events have been shown to affect the airflow patterns in the operating room setting. Door openings have been correlated with increased levels of contamination including increased numbers of colony forming units. A number of studies have assessed the number of door opening events that occur during surgery and have expressed concern with the high frequency of door opening events. Furthering our understanding of the effects of door opening on the operating room environment and exploring practical ways to monitor its occurrence will facilitate the implementation of enhanced safety practices in surgical environments and management of operating rooms.

A clinical study has shown that the total time that a door remains open during surgery affects the minimum room pressure recorded during the surgery, although pressure readings immediately before, after and during the exact time of door openings are unknown. One issue with this study is that pressure readings vary naturally throughout the day and minimum values can be a consequence of natural changes in pressure rather than door openings. Additionally, taking one minimum value per surgical procedure does not allow for the counting of door openings based on pressure changes. Devices can be attached to doors to detect openings; however, these methods can be difficult to implement and are subject to malfunction given that they are attached to or very near a large moving object.

What is needed, therefore, is a system and method that passively and automatically detects door openings and analyzes barometric pressure to facilitate reducing contamination and surgical site infections.

### SUMMARY OF THE INVENTION

A passive and automatic system and method are shown that automatically detects and counts door openings. The system and method described herein involve analyzing barometric pressure data collected from a single pressure sensor stationed inside an enclosed room. In the preferred embodiment, a single pressure sensor placed in the corner of an operating room can signal door opening/closing events through detection of rapid reduction and recovery of barometric pressure. Predetermined mathematical methods and systems are applied to the data to rapidly transform the data and automatically detect and count door openings. Barometric pressure values are collected preferably each second, allowing for rapid and abrupt changes to be captured and reported.

In one embodiment, the sensor need not be placed at the door to capture the pressure drop nor does it require more than one device to process pressure differences between adjacent rooms, allowing for a high degree of ease in sensor integration into the operating room environment. Automated electronic capture and recording is applied to track door opening events. In another embodiment, the system and method quantitatively examines the pattern of pressure drop and rise each time an operating room door is opened and closed. As is known, barometric pressure fluctuates naturally throughout the day, and another embodiment of the systems and methods described herein distinguish pressure changes induced by door opening events from background changes in pressure. The loss of positive pressure upon opening an operating room door has important implications for air quality in operating rooms. Loss of positive pressure combined with the presence of a large air exchange zone (the open doorway) creates a path for contaminants to enter the room. The systems and methods described herein utilize an algorithm and an equation that facilitates identification of pressure changes associated with door opening and automatically counts the door openings. A single equation can be applied to a set of barometric pressure data to rapidly count door openings. The systems and methods described herein contribute to a wider effort of identifying, understanding and reducing adverse events in operating rooms in pursuit of improving surgical standards and enhancing patient safety.

Certain rooms in hospitals are slightly pressurized to prevent influx of contaminants when doors are opened. It is desired to know how often and how long such doors are opened, in order to assess the contamination which results. An object of the invention is to provide a non-contact detector for detecting and counting door-opening events and the duration of those events.

One object of the invention is to provide a passive method for automatically detecting and counting door opening events.

Another object of the invention is to passively and automatically detect and count door opening events using at least one sensor.

Still another object of the invention is to provide a passive system and method for automatically detecting and counting door opening events utilizing a single pressure sensor.

Yet another object of the invention is to provide a passive system and method for automatically detecting and counting door opening events utilizing at least one sensor that is not coupled to and/or is remote from the door.

Still another object of the invention is to provide a system and method that automatically and electronically captures, records and tracks door opening events and examines a pattern of pressure drops and rises associated with such events.

Another object of the invention is to provide a system and method that quantitatively examines a pattern of pressure drops and rises each time a door, for example a door in an operating room, opens or closes.

Yet another object of the invention is to provide a system and method that includes and utilizes a predetermined equation that facilitates identification of pressure changes associated with the door openings and closings and automatically counts the door openings and performs a response thereto.

Still another object of the invention is to provide a single equation that can be applied to a set of barometric pressure data to rapidly count a door opening event pressure data sensed from at least one sensor.

Another object of the invention is to provide a system and method that utilizes a single pressure sensor to generate pressure data and to determine a door opening event in response thereto.

Yet another object of the invention is to provide a system and method that utilizes a single pressure sensor that is situated remote from a door in a room, such as an operating room, and that utilizes an equation to distinguish pressure changes induced by door opening events from background changes in pressure unrelated to door opening events.

Another object of the invention is to provide an improved system and method for sensing door opening events and for taking action, such as increasing a pressure in the room, in response thereto in order to improve surgical standards, enhance patient and operating personnel safety and the like by facilitating reducing airborne contamination in the room.

In one form of the invention, a pressure sensor produces a record, which contains a sequence of measurements of barometric pressure in a pressurized room. An opening door produces a characteristic, though small, sequence of pressure pulses. The invention looks for the characteristic sequence in the data or record and when the sequence is found, the invention declares and identifies that a door has opened.

In one aspect, one embodiment of the invention comprises a method of detecting opening of a portal in a pressurized room, comprising measuring a sequence of barometric pressures at a fixed location within the room; and based solely upon pressures within the sequence, identifying a sub-sequence during which the portal had opened.

In another aspect, another embodiment of the invention comprises a method of detecting opening of a portal in a pressurized room, comprising generating a history of barometric pressures at a fixed location within the room; and using the history and no other data, ascertaining whether the portal had opened.

In yet another aspect, another embodiment of the invention comprises a method, comprising obtaining data on barometric pressure within a room over a span of time; ascertaining whether sections of the data meet predetermined criteria; and if so, issuing a signal indicating that a portal in the room has opened during the span of time.

In still another aspect, another embodiment of the invention comprises a system for a pressurized room in which (A) barometric pressure varies daily between a maximum Pmax and a minimum Pmin, and (B) opening a portal in the room causes a pressure disturbance Pd which is less than 10 percent of (Pmax - Pmin), comprising a recording system for producing a record of the barometric pressure within the room over a span of time, and an analyzing system for detecting a pressure pattern indicative of an open portal in a wall of the room and, in response, issuing a portal-open signal.

In another aspect, another embodiment of the invention comprises a method to track door openings comprising using a barometric pressure sensor; performing electronic data collection of pressure readings as a function of time; processing and analyzing the data to ascertain door opening events; applying an equation to transform the data to facilitate identification of door opening events; and applying a program to automatically count a number of door openings based on the transformed data.

In another aspect, another embodiment of the invention comprises a method for measuring changes in barometric pressure at a predetermined location after a door opens, the method comprising the steps of measuring barometric pressure at the location at different times, and if measured barometric pressures meet predetermined criteria, generating a signal indicating that the door has opened.

In another aspect, another embodiment of the invention comprises an apparatus for a room having a portal which opens and closes, comprising within the room, a non-moving pressure sensor at a fixed location, which produces a history of barometric pressure in the room, the history containing (1) an early interval, (2) a middle interval, and (3) a late interval; a processor which derives a figure-of-merit for each interval and, based on the figures-of-merit, concludes whether the portal has opened during one of the intervals.

In another aspect, another embodiment of the invention comprises a method of detecting opening of a portal in a pressurized room, comprising generating a history of barometric pressures at a fixed location within the room; identifying midpoint T11 of the history; deriving an indicator IN1 of amount of scatter of pressures occurring before the midpoint; deriving an indicator IN2 of amount of scatter of pressures occurring after the midpoint; computing pressure drop A immediately preceding T11; computing pressure drop D immediately following T11; computing a pressure drop B based on A and B; based on A, B, D, IN1, IN2, and a correction factor, issuing a signal indicating that the portal has been opened.

In another aspect, another embodiment of the invention comprises a method of detecting opening of a portal in a pressurized room, comprising obtaining a sequence of barometric pressure for a normally closed room; defining (1) early, (2) middle, and (3) late periods in the sequence; deducing amount of scatter in pressures of both the early and late periods; deducing trending in pressure in the middle period; and based on deductions of paragraphs (b) and (c), issuing a signal indicating that a portal to the room had opened while the sequence was taken.

In another aspect, another embodiment of the invention comprises a method of analyzing a sequence of barometric pressure data taken from a normally closed room, comprising dividing the sequence into (1) early, (2) middle, and (3) late periods; ascertaining early scatter in the early period, and late scatter in the late period; ascertaining a trend in the middle period; based on (i) early scatter, (ii) late scatter, and (iii) inflection weight, issuing a signal indicating that a portal to the room had opened while the sequence was being generated.

In another aspect, another embodiment of the invention comprises a method of detecting opening of a portal in a pressurized room, comprising obtaining a sequence of 21 pressure measurements, N1 through N21, each at a respective time T1 through T21, and all measured within the room at a fixed location remote from the portal; computing pressure drop A between times T10 and T11; computing pressure drop B between times T10 and T12; computing pressure drop D between times T11 and T12; computing standard deviation C of ten pressures T1 through T10; computing standard deviation E of ten pressures T12 through T21; computing SUM = A + B - C -D + E - 0.105; and if SUM is positive, issuing a signal indicating that the portal has been opened between T1 and T10.

In another aspect, another embodiment of the invention comprises a door opening tracking system for positive pressure rooms comprising a continuous barometric pressure sensor; an electronic data processing system comprising a noise reduction means; calculation of a temporally based data packet comprising a moving pressure data baseline and a discrete pressure event or spike, a spike threshold determination, and a data storage and retrieval means.

In another aspect, another embodiment of the invention comprises a method for identification of door openings in a positive pressure operating room comprising pressure sensing creating a continuous data stream; creating at least one data packet consisting of a set of pressure values over a predetermined period of time; entering the data packet into the data memory of a date processing device; and electronic reporting of the door openings.

This invention, including all embodiments shown and described herein, could be used alone or together and/or in combination with one or more of the features covered by one or more of the following list of features:
The system in which the analyzing system detects the pressure pattern without reference to any data outside the record.
The method wherein the method further comprises the step of using a barometric pressure sensor, including a MEMs-based barometric pressure sensor, to monitor door openings.
The method wherein the method further comprises the step of interfacing technology with an air cleaning and disinfecting device.
The method wherein the method further comprises the step of using a barometric pressure sensor to monitor door openings in an operating room setting.
The method wherein the method further comprises the step of locating a door monitoring system in a position that is not in contact with a door in the room or placed between the door and door frame.
The method wherein the method further comprises the step of using a pressure sensor in the periphery of a room, including an operating room, to monitor door openings via detected changes in pressure upon opening the door.
The method wherein the method further comprises the step of mathematically transforming barometric pressure data to facilitate the identification of door opening events.
The method wherein the method further comprises the steps of calculating barometric pressure changes over time; and comparing with the standard deviation of the barometric pressure over time to identify door opening events.
The method wherein the method further comprises the step of analyzing barometric pressure data several seconds before and several seconds after a specific time parameter in order to identify whether or not a door opening event occurred within the time-frame of the time parameter including 10 seconds before or after the time parameter.
The method wherein if barometric pressure, n, is detected and recorded every second, the method further comprises the step of using the following equation to analyze a series of sequentially recorded data, x(t) = √[(n₁₀ - n₁₁) + (n₁₀ - n₁₂) -σ(n₁ ... n₁₀) - (n₁₁ - n₁₂) + σ(n₁₂ ... n₂₁) - 0.105] where nₜ is the barometric pressure at time, t, σ is the standard deviation of the specified range and x is a real number or an imaginary number (square root of a negative number) and indicates whether or not a door opening event has occurred or has likely occurred within the time range of t to t + 1 s, and up to a range of t to t + 10 s; when x is a positive number, a door opening event has occurred; when x is a positive number, a door opening event is likely to have occurred; when x is an imaginary number a door opening did not occur or very likely did not occur; the equation also being written as x(t) = √[(J - K) + (J - L) - σ(A ...J) -(K - L) + σ(L ... U) - 0.105] where A... U are the barometric pressure values at time t.
The method wherein the method further comprises the step of using a programming function to count door openings based on output derived from the equation, including counting the number of data points in a data set where outputs are values greater than zero as derived from the equation.
The method wherein the method further comprises the step of incorporating the application of the equation and automated counting in a pressure sensing device.
The method wherein the method further comprises the step of incorporating a pressure sensor, the application of the equation and automated counting in an air monitoring device.
The method wherein the method further comprises the step of incorporating a pressure sensor, the application of the equation and automated counting in an air cleaning device.
The method wherein the method further comprises the step of transforming barometric pressure data into an output that counts door opening events.
The method wherein the method further comprises the step of isolating relatively large pressure changes induced by door openings from natural variations in barometric pressure so that door opening events can be distinguished.
The method wherein the method further comprises the step of monitoring door openings by analyzing barometric pressure changes in operating rooms under positive pressure.
The method wherein automated electronic output of door openings is based on the equation.
The method wherein in the equation the last term (0.105) is varied between 0.1 and 0.12.
The method wherein in the equation the last term is computed based on room specific parameters which can include, and are not limited to, size, positive pressure, number of doors and ventilation level.
The method wherein the method may be applied to any enclosed space under positive pressure.
The method wherein the method may be applied to any enclosed space with a door attached to a hinge.
The method wherein the method further comprises the step of transforming a set of pressure loss data associated with a door opening event into a single point associated with the event.
The door opening tracking system wherein the barometric pressure sensor comprises a sensor that detects atmospheres pressure via piezo-resistive, capacitance, deposition, wire, mechanical or equivalent means to generate an electrical signal on a continuous basis.
The door opening tracking system wherein transmitting and/or recording pressure data occurs every 10 seconds or less.
The door opening tracking system wherein the electronic data processing system comprises data input from the pressure sensor, processing of the data, output of the data to a data storage and retrieval system.
The door opening tracking system wherein the data processing comprising curve flattening and/or noise reduction to remove variations from normal environmental and atmospheric changes in barometric pressure; the processing comprising a denoising means such as filtration, averaging, wave transformation, denoising algorithm or similar process.
The door opening tracking system wherein the data processing further comprising a moving temporal baseline or moving frame means to isolate discrete, shot term pressure deviation events which occur from door opening from a positive pressure environment to a lower pressure environment; the temporal frame and the deviation comprising a data packet.
The door opening tracking system wherein the data processing comprising an amplification of deviation events and/or packets.
The door opening tracking system wherein the data processing system, wherein processed deviation events are transformed into discrete data points representing the door openings.
The door opening tracking system wherein deviations within the packets are compared to a predetermined threshold level.
The door opening tracking system wherein the events which exceed a predetermined threshold level are recorded in a data storage and retrieval system.
The method wherein the data packet comprises a central value in the substantial midpoint of the packet; an upstream proximate value occurring shortly before the central value; a downstream proximate value occurring shortly after the central value; a set of upstream distant values occurring prior to the upstream adjacent value; and a set of downstream distant values occurring after the downstream adjacent value.
The method wherein the method compares the central value with upstream and/or downstream proximate values and calculates a central deviation.
The method wherein the method further comprises the step of determining deviations within sets of the upstream and/or downstream distant sets, creating a blended value of deviation s, via averaging via mean, median, mode, range or similar means.
The method wherein the method further comprises the step of comparing the central value deviation with a common value of distant deviations, creating a central deviation set.
The method wherein the central deviation set undergoes a filtration function to remove upward pressure deviations to create a filtered set.
The method wherein the filtered set results in discrete spike values at recorded time points, the nonzero points and their associated times output into a data recording and/or transmission system.
The method wherein the filtered set results in discrete spike values at recorded time points, of greater spike deviation than a predetermined threshold; the spike values and their associated times points into a data recording and/or transmission system.
The method wherein a data reading frame advances one discrete sensor data value after the calculation of the spike values, creating a new data packet with a central value at the previous downstream proximate value to create a substantially continuous moving packet frame.

These and other objects and advantages of the invention will be apparent from the following description, the accompanying drawings and the appended claims.

### BRIEF DESCRIPTION OF THE ACCOMPANYING DRAWINGS

FIG. 1 is a flow chart of procedures undertaken by one form of the invention;

FIG. 2 illustrates a room containing a door and a pressure barometric pressure sensor;

FIG. 3 is a hypothetical plot of a pressure wave produced by an opening door; Based on my data, I would draw the wave so that the pressure is recovered when it closes, it’s a quite rapid process; it reaches the lowest level of pressure quite rapidly (within 3 seconds, it does not continually lose pressure while the door is open, it hits the bottom range quickly and recovers quickly when it closes);

FIG. 4 illustrates a plot of 3,600 points in time, at which pressure measurements are taken;

FIG. 5 is a sub-set of the plot of FIG. 4 and contains an equation utilized by one embodiment of the invention;

FIG. 6 illustrates computation of standard deviation;

FIGS. 7 - 18E illustrate various exemplary pressure distributions which can be produced by barometric pressure sensor in FIG. 2;

FIGS. 8A and 12A shows three bell curves and a representative standard deviation for each;

FIG. 17A shows daily variation in atmospheric pressure;

FIG. 19 shows how the sequences of FIGS. 18 affect the equation in one embodiment;

FIGS. 20A - 20F show the successive processing of individual groups of numerous pressure measurements each; and

FIG. 21 is a view of raw data and corresponding easy-to-count pressure drop spikes.

### DETAILED DESCRIPTION OF THE PREFERRED EMBODIMENTS

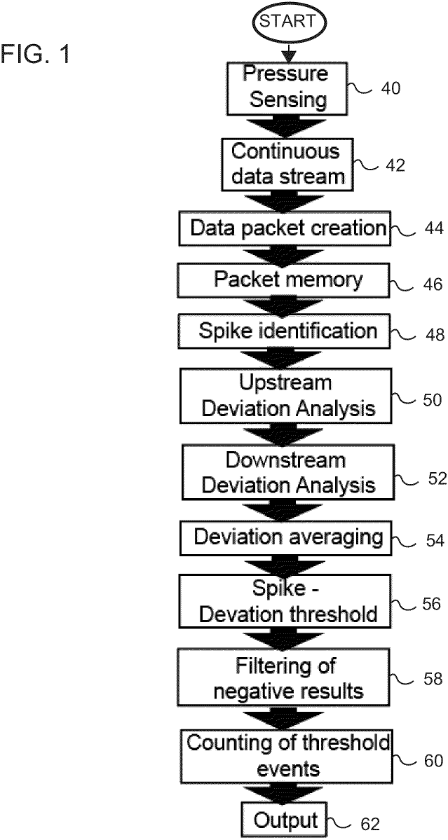

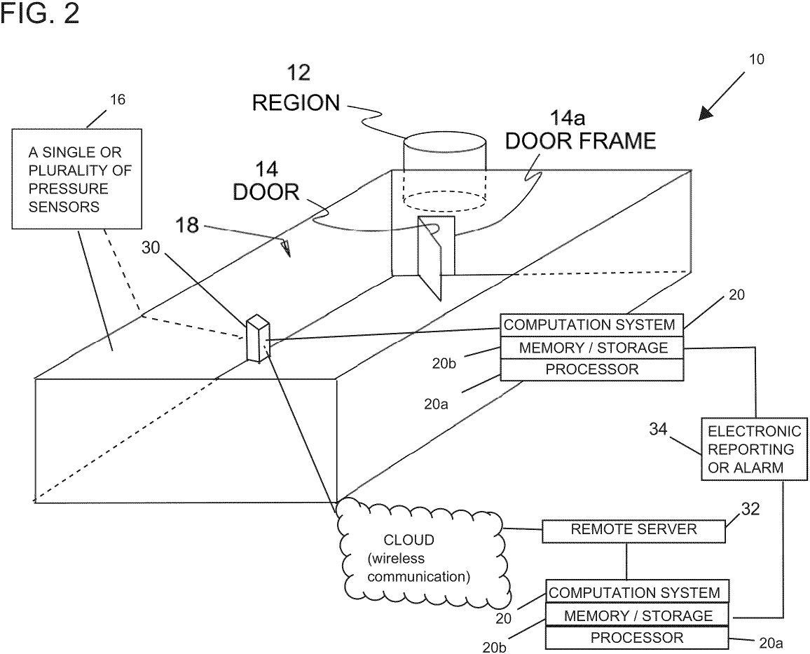

FIGS. 1 and 2 are schematic views of a system, method and apparatus 10 that can detect an opening of a door 14 (FIG. 2) in a room 18. The room 18 may be an operating room or other area or room, such as a patient room in a hospital.

FIG. 2 shows the room 18 in which a positive pressure is maintained, compared to a region 12 outside the door 14. In one embodiment, the door 14 is of the self-closing type, to avoid excessive loss of pressure in the room 18. A barometric pressure sensor 16 is located at a fixed position in the room 18, but it does not have to be located at, on or near the door 14 in this illustration.

In one embodiment, the barometric pressure sensor 16 is a micro electromechanical system (MEMs) based barometric pressure sensor. The barometric pressure sensor 16 comprises a sensor that detects atmospheric pressure that may use different sensing approaches, such as a piezo-resistive sensing approach, capacitance sensing approach, deposition sensing approach, a wire, a mechanical or other equivalent means to generate an electrical signal on a continuous basis that responds to the pressure changes in the room 18. In this case the wire and mechanical means were mechanisms of electrical signal transport or creation. For example, a piezo device can produce electricity upon undergoing mechanical deformation. As far as detection methods go, the sensor used in one embodiment is a MEMs sensor.

The barometric pressure sensor 16 is not in contact with either the door 14 or the door frame 14a but is remote from both. In one form of the invention, the barometric pressure sensor 16 is located in the maximum possible distance from the door 14, while still remaining within the room 18. In another form of the invention, the barometric pressure sensor 16 is located at least half that maximal distance from the door 14.

A schematic block 20 in FIG. 2 represents a computation system and apparatus used in one embodiment of the invention. The barometric pressure sensor 16 produces an output indicating pressure in milli-bars (“mB”), with a resolution of 0.1 mB, for example. The barometric pressure sensor 16 can distinguish between a pressure of 950 mB and 950.1 mB. In one embodiment, the barometric pressure sensor 16 may be the LPS33W MEMS pressure sensor, which is available from STMicroelectronics located in Geneva, Switzerland.

As mentioned, the barometric pressure sensor 16 does not have to be located at or near the door 14, but rather can be in the periphery of the room 18. The computation system and apparatus 20 is situated in the room 18 and may be incorporated on or into an air cleaning and disinfection device 30 or may be located remotely on a remote server 32. In that embodiment, the barometric pressure sensor 16 and/or the air cleaning and disinfection device 30 in the room 18 may comprise conventional wireless communication technology (not shown) that permits transmission to the remote server 32 in a manner that is conventionally known.

As alluded to earlier, it should be understood that an algorithm or equation 36 may be resident in the barometric pressure sensor 16 or stored in memory or storage 20b of the computation system and apparatus 20 so that the barometric pressure sensor 16 outputs sensed data directly thereto for processing. The algorithm or equation 36 is described in detail later herein and generally automatically counts door 14 opening events and then the number of output events which indicate door opening events derived in equation 36 described later herein. Alternatively, and in another embodiment, the barometric pressure sensor 16, the application of the algorithm or equation 36 and the computation system and apparatus 20 are situated in either the air cleaning and disinfection device 30 or a remote server 32.

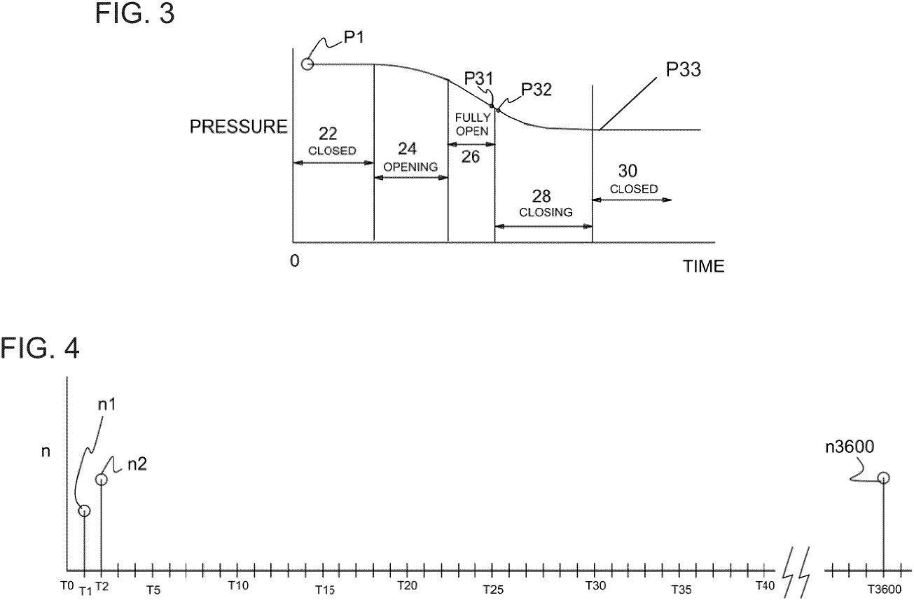

The barometric pressure sensor 16 takes a sequence of pressure readings, such as that illustrated in FIG. 3, which shows a range of 0-3600 or n-n3600 pressure readings. One reading is labeled n1, which was sensed or taken at time T1. Another is labeled n2 and was taken at time T2, and so on through n3600, which was taken at time T3600. In one illustrative embodiment, they are taken at one-second intervals for a total duration of 3600 seconds, which equals one hour. Of course, more or fewer readings may be taken as well.

In a preferred embodiment, the system, method and apparatus 10 examines the sequence of pressure data and these are processed as described herein in order to ascertain patterns or sequences which indicate when the door 14 in FIG. 2 has opened. FIG. 4 is a simple illustrative plot of a pressure pattern which may be produced, with various related door 14 events (e.g., opening, closing, etc.).

Initially, at time zero, the pressure P1 is above external ambient pressure in region 12 of FIG. 2 because of the positive pressure in room 18 in FIG. 2. In the illustration, an agency, such as a blower, may or may not be active at this time to maintain the higher pressure P1 in the room 18.

The plot in FIG. 3 is broken down by zones or regions 22, 24, 26, 28 and 30 which correlates to various door 14 opening and closing events as shown. In region 22 in FIG. 3, pressure is stable because the door 14 in FIG. 1 remains closed. In region 24, pressure in the room 18 begins to drop as the door 14 opens and the pressure drops faster as the door 14 opens wider in region 26 because the door 14 acts like an opening valve, allowing progressively more air to escape from the room 18.

In region 26, the door 14 is fully open and remains fully open for some period of time for illustration. It should be understood that the period may be short, as when the door 14 was opened by a person entering the room 18, who then immediately releases the door 14 or allows it to close after the person fully enters or exits the room 18 or door frame 14a. On the other hand, the period may be long, such as when two people enter or exit the room 18 through the door frame 14a with a gurney, bed or equivalent.

The data shows that the pressure drop is fast, but the pressure restores quickly. Thereafter, the door 14 closes in region 28. The pressure initially continues to decrease at the same rate as at the end of region 26 because the door 14 opening or aperture is the same at points 31 and 32 in the plot. Note that pressure drop or airflow rate decreases because the door 14 is closing, which interrupts or decreases airflow out of or into the room 18 so that the pressure becomes constant in region 30 after closure completes. The pressure P33 in region 30 is lower than pressure P1 because of the loss of air from the room 18. As the heating ventilation air conditioning (HVAC) or other means forces air into the room 18, the pressure will rise back to the predetermined level at P1. In theory, a pressure wave (not shown) can occur at the moment of complete closure of the door 14 because the complete closure causes an instantaneous deceleration of the air flowing through the door frame 14a, analogous to water hammer which occurs in a plumbing system when a water valve is closed. A similar comment applies to a possible pressure wave at the initial moment of opening.

As mentioned, there may be an agency pressurizing the room 18, such as an HVAC blower (not shown), which may attempt to restore pressure to the predetermined initial pressure P1. Alternatively, the agency may have been called into service at some point during the events of FIG. 4. That agency may alter the plot of FIG. 4.

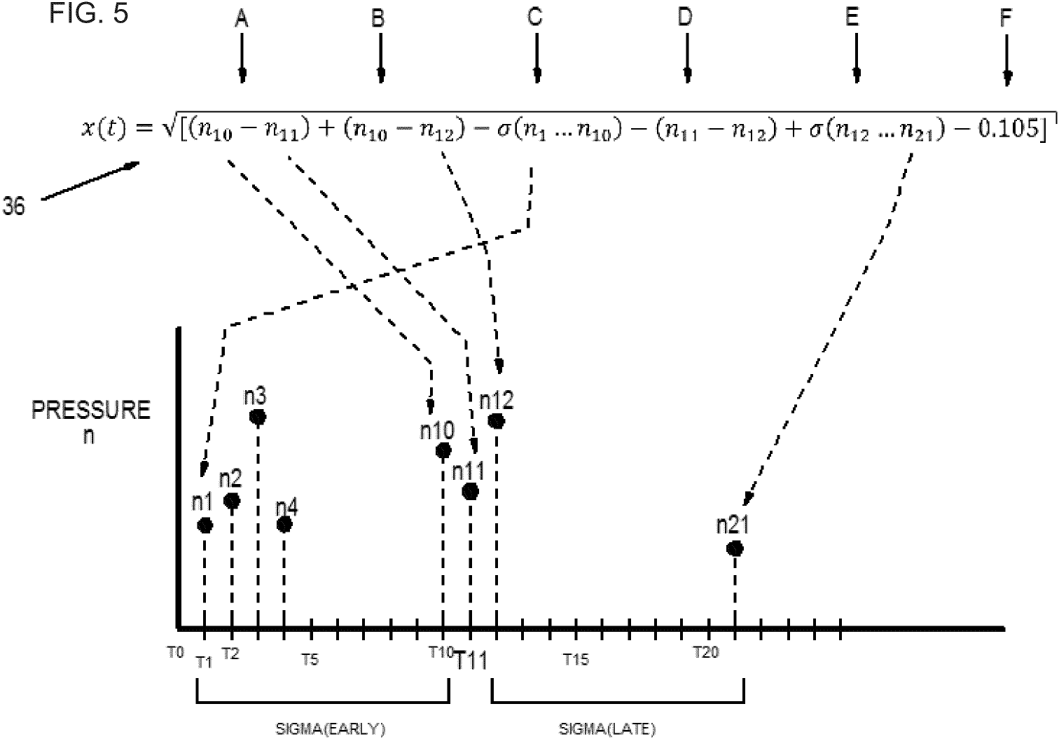

FIG. 5 shows a sequence of twenty-one (n1 - n21) illustrative pressures produced by the barometric pressure sensor 16 in FIG. 1. It should be understood that more or fewer pressure readings or senses may occur. Those twenty-one (n1 - n21) illustrative pressures are a sub-set of the illustrative sequence of pressures shown in FIG. 3. One form of the invention utilizes an equation or algorithm 36 in FIG. 5. That equation is as follows:

$$\begin{matrix}x \left(t\right) = \\ √ \left[\left({n}_{10} - {n}_{11}\right) + \left({n}_{10} + {n}_{11}\right) - σ \left({n}_{1} … {n}_{10}\right) - \left({n}_{11} - {n}_{12}\right) + σ \left({n}_{12} … {n}_{21}\right) - 0.105\right]\end{matrix}$$

The correspondence between the terms of the equation and the twenty-one (n1 - n21) illustrative pressures is indicated by the dashed arrows. It is to be noted that more or fewer pressure pairs or variable combinations, such as the variables (n10 -n11), (n1, ... n10), may be used. Some pressures, such as n10, appear more than once in equation 36, but a dashed arrow is drawn for only one appearance and ease of illustration. The Greek lower case sigma (σ indicates a standard deviation). That is, the expression “σ(n1 ... n10)” means “standard deviation of pressures n1 through n10”. For ease of understanding and type-setting, the expression “σ(n1 ... n10)” will be written “SIGMA(n1 ... n10)” in this description.

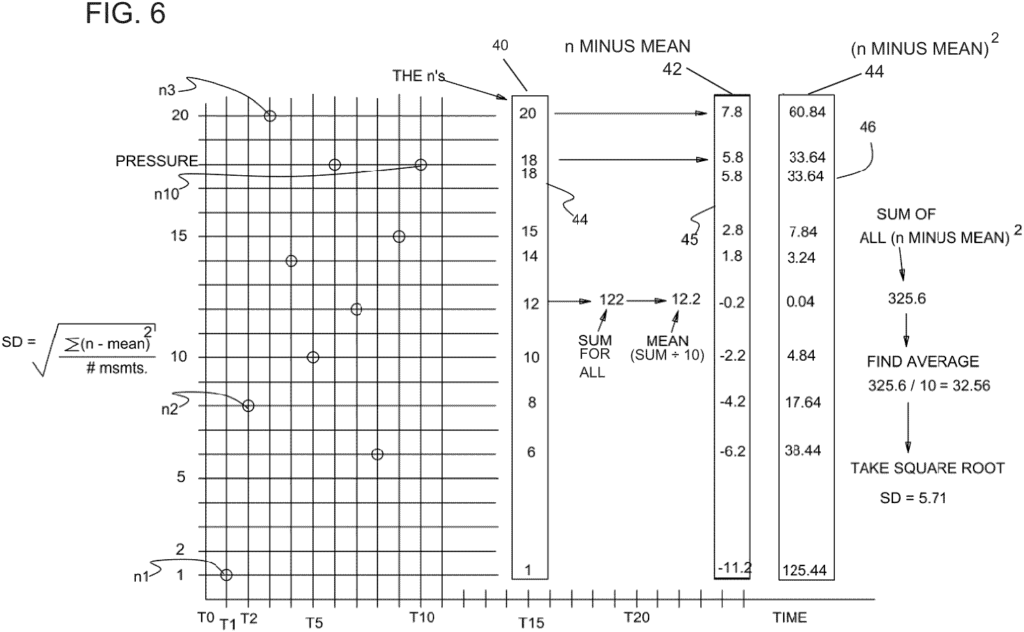

Referring back to the example in FIG. 5, time T11 is roughly a midpoint of a time duration between T1 and T21: there are ten instants of time after T11 (T12 through T21) and also ten instants of time before T11 (T1 through T10). For ease of understanding and illustration and as shown at the bottom of FIG. 5, the standard deviation for those ten instants before time T11 can be called SIGMA(EARLY) because they occurred before, or earlier than time T11, which is the mid-point. The standard deviation for the ten instants after T11 can be called SIGMA(LATE) because they occurred after T11. “Standard deviation” is a term of art in the science of statistics, and FIG. 6 gives an example of computing it relative to the embodiments described herein. Ten pressures, n1 through n10, are indicated for the respective times T1 through T10. The box or area 40 in FIG. 6 contains several illustrative pressures. One first adds all the pressures together to find their sum. Then one finds the average, or mean, by dividing by the number of pressures. In the example, the sum is 122 for ten pressures, so the average or mean is 12.2.

It should be understood that the data generated by the barometric pressure sensor 16 is analyzed for a first predetermined amount of time before and a second predetermined amount of time after a specific time parameter in order to identity whether or not a door 14 opening event occurred within the timeframe of the time parameter. For example, the first and second predetermined amounts of time may be a few seconds or several seconds before and after or in one embodiment, it could be ten seconds before and/or ten seconds after the specific time parameter. The specific time parameter is the time in which a door 14 induced change in pressure is detected. In the equation and routine provided, it lasts for two seconds, but could be longer or shorter. It represents the time during the calculated difference between the pressure when the door 14 is closed and when it is open. Although the specific time parameter is two seconds, it could be longer or shorter, and it may change in response to various conditions, such as door size and type, door closing time, room pressure and the like, it is best to use the first two seconds.

Thereafter, the mean is subtracted from each pressure, as indicated in box or area 42, and each average or mean result is squared, as indicated in box 44. All squared values in block 44 are added together to produce 325.6 value as shown at the right side of FIG. 6. The average sum of the squared values is 32.56. The square root of that is 5.71 and equals the standard deviation, SD or σ. The significance of these variables and calculations will become readily apparent as applied and utilized to measure pressure from a few or even a single barometric pressure sensor 16. In this regard, there may be a plurality of barometric pressure sensors 16, or in a preferred embodiment, just one barometric pressure sensor 16. If a plurality of sensors are used, then they are individually analyzed and the data from each sensor is not averaged together. Instead, each sensor’s data may be analyzed as its own set. This is believed to improve the accuracy of the door 14 counting. For example, if there were ten sensors and only the data from one sensor resulted in a door 14 opening being counted, then it’s probably a false positive. If data from all ten sensors resulted in a counted door 14 opening, then it’s likely a door 14 opening, so accuracy of a door 14 opening event is improved.

As mentioned earlier herein, the barometric pressure sensor 16 does not have to be located near the door 14 or, for example, activated or tripped by the door 14 opening. The barometric pressure sensor 16 does not have to be located on/or adjacent to or on the door 14, but rather can be located remote from it. In one embodiment, the barometric pressure sensor 16 is located in the room 18 and coupled to the computation system and apparatus 20 which is described in more detail later herein. Alternatively, it should be understood that the barometric pressure sensor 16 is situated in the air cleaning and disinfection device 30 which is situated in the room 18. The air cleaning and disinfection device 30 may be the ILLUVIA® system available from Aerobiotix, LLC located in Miamisburg, Ohio. The air cleaning and disinfection device 30 may be portable and moved to different areas of the room 18. It should also be understood that the computation system and apparatus 20 may also be separately located in the room 18, such as with the barometric pressure sensor 16, or be in or on the air cleaning and disinfection device 30. Alternatively, and as shown in FIG. 2, it should be understood that the air cleaning and disinfection device 30 may be adapted to provide wireless communication conventionally so that the data described herein may be transferred wirelessly to a remote server 32 (FIG. 2) that comprises or is adapted to communicate with the computation system and apparatus 20.

In one embodiment of the invention, the sensor 16 is a barometric sensor, such as LPS33W MEMS pressure sensor available from STMicroelectronics located in Geneva, Switzerland.

The computation system and apparatus 20 comprises a processor 20a and the memory or storage 20b. It should be understood that the algorithm or equation 36 may also be independent from the computation system and apparatus 20. It can be calculated using the collected data anywhere the data is located. It can be used manually via a spreadsheet on any computer, when the data is stored in a cloud database, sch as memory or storage 20b, it can be used there or it can be resident on the computation system and apparatus 20 and used there.

As described earlier herein, the barometric pressure sensor 16 senses the barometric pressure and data associated with that sensed event is stored in the computation system and apparatus 20 in the memory or storage 20b of the processor 20a. The algorithm represented by the equation 36 as shown in FIG. 5 and is embodied in the process shown in FIG. 1, which will now be described. The process or method begins at block 40 with the pressure sensing event by the barometric pressure sensor 16. In response, the computation system and apparatus 20 generates a continuous data stream at block 42 and a data packet is created at block 44. The packet is stored in memory or storage 20b at block 46 and the processor 20a processes the data by first identifying the spikes in the data that may determine a spike in the pressure in the room 18. It should be understood that the spike could be a decrease or an increase in the pressure sensed at block 48 in FIG. 1. As described earlier herein, at blocks 50 and 52 in FIG. 1, the analysis is performed by the computation system and apparatus 20 and processor 20a performing an upstream and downstream deviation analysis as described herein. At block 54, deviation averaging is performed. The standard deviation over a specific time frame, for example, may be over a 10 second time frame, which shows the natural variations in a given block of time and a spike deviation threshold is determined at block 56 when the changes in pressure relative to a reference point exceeds the standard deviation and the correction factors in the equation. At block 58, negative results are filtered. It should be understood that because the square root of a negative number cannot generate a real number, anywhere a negative number is calculated will result in a final value of “0” which essentially designates an error, leaving only positive spikes. Thereafter, at block 60, a counting of the threshold events occurs. All threshold events greater than 0 get counted, and as mentioned, a threshold event signifies a door 14 opening event. This counting can be automated using the Microsoft Excel® “COUNTIF” function command. Once the threshold events are counted, the procedure continues at block 62 where an output report that counts the door 14 opening events is generated.

The system, method and apparatus 10 generates a report for appropriate personnel, such as the operating room manager, to assess and determine if improvements or changes need to be made regarding door 14 operation, door 14 openings, room pressure and the like. Also, the information can be used to understand likely causes of surgical site infections.

Advantageously, the system, method and apparatus 10 provides and defines a tool to help understand the dynamics, safety and functionality of the operating room and where there is room for improvement. At a minimum, customers may be provided with regular reports comprising a variety of data including the number of door 14 openings based on the system, method and apparatus 10 described herein.

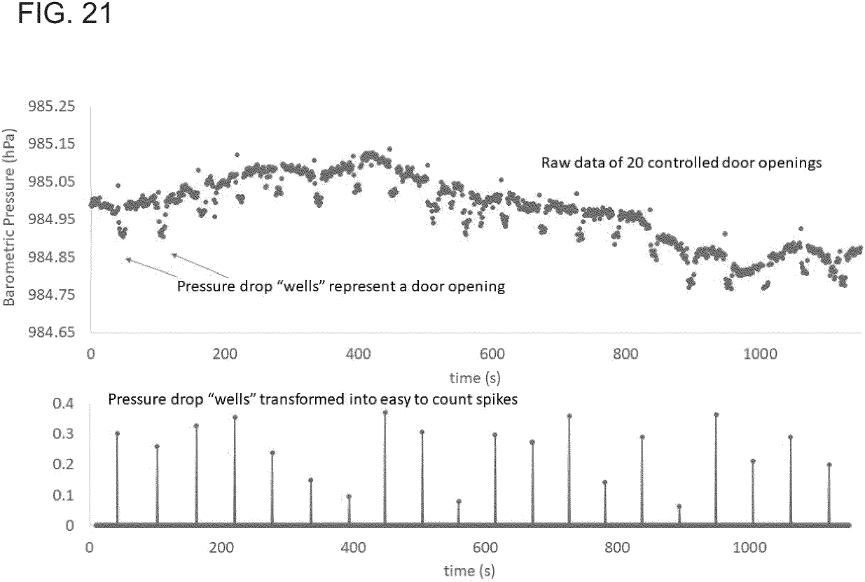

Several internal experiments were performed consisting of twenty (20) door 14 openings with the associated data shown in FIG. 21.

The air cleaning and disinfection device 30 contains many sensors, one of which is the MEMS barometric pressure sensor 16. The air cleaning and disinfection device 30 collects data from all the sensors, and the system, method and apparatus 10 generates a Microsoft Excel® file of the data. It should be understood that the system, method and apparatus 10 may transfer the data to a remote server 32 or to the air cleaning and disinfection device 30 computation system and apparatus 20 and memory or storage 20b thereof for processing by computation system and apparatus 20.

The application of the algorithm and characteristics of the equation 36 will now be described.

As shown earlier, equation 36 is as follows and is represented in several of the figures.

$$\begin{matrix}x \left(t\right) = \\ √ \left[\left({n}_{10} - {n}_{11}\right) + \left({n}_{10} + {n}_{11}\right) - σ \left({n}_{1} … {n}_{10}\right) - \left({n}_{11} - {n}_{12}\right) + σ \left({n}_{12} … {n}_{21}\right) - 0.105\right]\end{matrix}$$

Referring back to FIG. 5, Equation 36 in FIG. 5 contains three pressure differentials, labeled A, B, and D. It contains two standard deviations, labeled C and E, and one correction factor, labeled F. A door 14 opening event is inferred from the algebraic sign of the bracketed term (containing items A through F). If that term is negative, then x(t), being a square root, will be imaginary. That indicates that no door 14 opening has occurred.

On the other hand, if the bracketed term is positive, then that is taken or interpreted to indicate that a door 14 opening has occurred at some time between T1 and T10. It is noted that the door 14 opening, which is inferred by equation 36, occurred at a time in the past and is inferred based on the historical record of pressures shown in FIG. 5. It is important to understand that this is a different situation from an inference made by a mechanical switch (not shown) which is tripped by the door 14 opening or closing. In the prior art, the door switch is tripped at the same time the door 14 opens.

In contrast, the pressure differentials A, B, and D (FIG. 5) occur in the central time region of T10 through T12. They can be defined as pressure drops in the following sense. In differential A, if n11 is less than n10, then the term (n10 - n11) will be positive. The positive (n10 - n11) is a pressure drop. However, if n11 is greater than n10, the term (n10 - n11) will be negative. The negative (n10 - n11) is a pressure rise because n11 is greater than n10. So, a positive pressure differential is determined to be a pressure drop, and a negative differential is determined to be a pressure rise. It is noted that all three differentials, A, B, and D, are directional in the sense that a later pressure (n11, n12, and n12) is subtracted from an earlier pressure (n10, n10, and n11, respectively, in the example).

The term labeled A, namely (n10 - n11), can be called the pressure drop preceding the midpoint T11.

The term labeled D, namely (n11 - n12), can be called the pressure drop succeeding the midpoint T11.

The term labeled B, namely (n10 - n12), can be called the pressure drop spanning the midpoint T11. It is the pressure drop between the times T10 and T12, which span T11.

The pressure drops labeled A and B are positive or have positive signs in equation 36 and are added to the other terms within the brackets. However, the pressure drop labeled D has a negative sign. That is, the pressure drop succeeding the midpoint T11 and labeled D tends to counter-act the pressure drop preceding the midpoint T11 and labeled A, as to their influences on the bracketed term in equation 36. It should be understood that pressure drop labeled D corrects for false positives.

Terms C and E are standard deviations. Term C can be called SIGMA(EARLY) because it is the standard deviation of the early pressures, namely, those occurring before time T11. Term E can be called SIGMA(LATE) because it is the standard deviation of the late pressures, namely, those occurring after time T11.

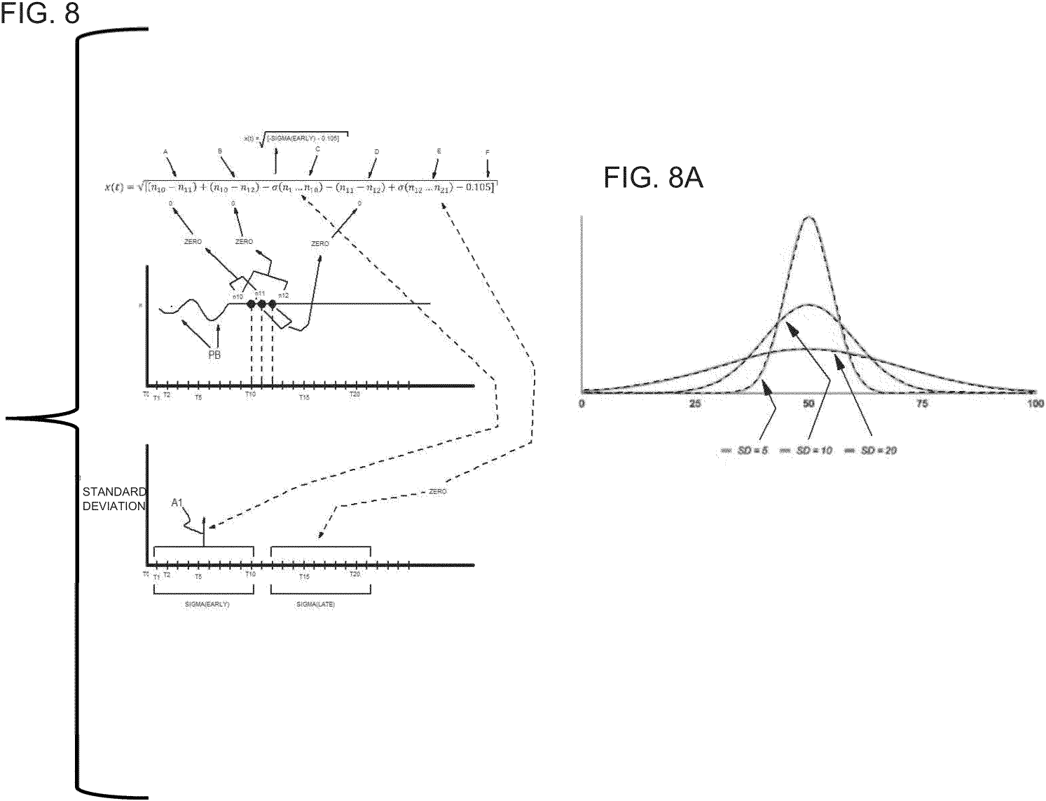

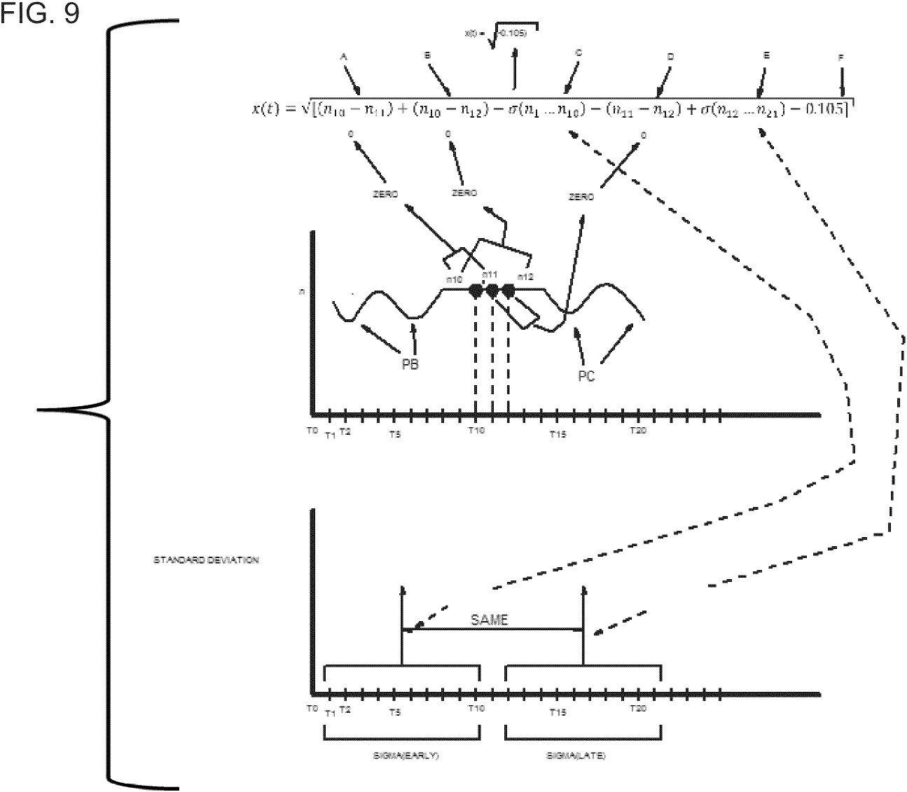

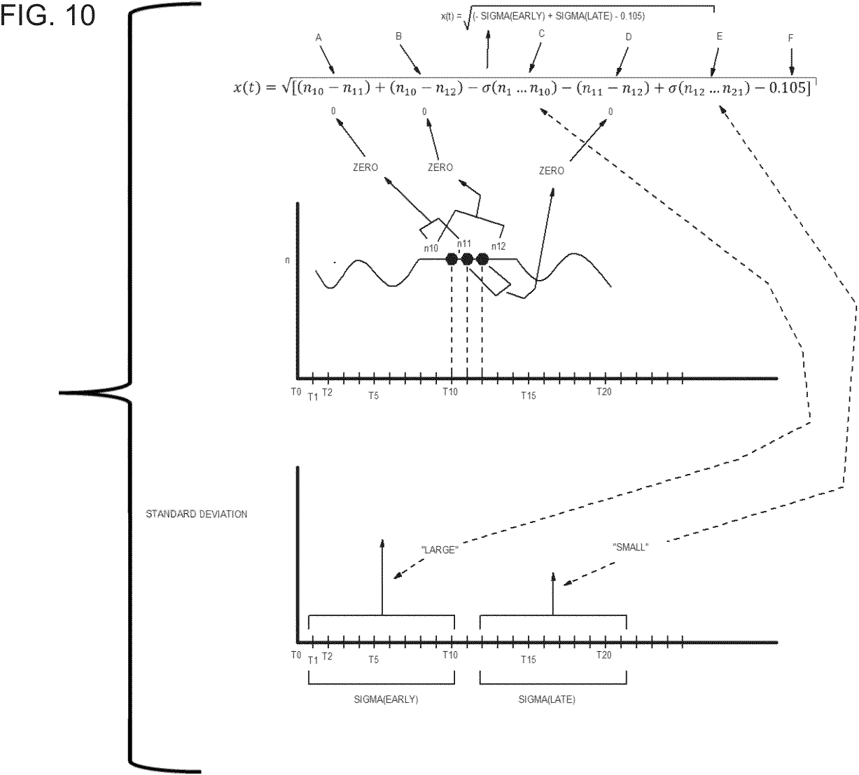

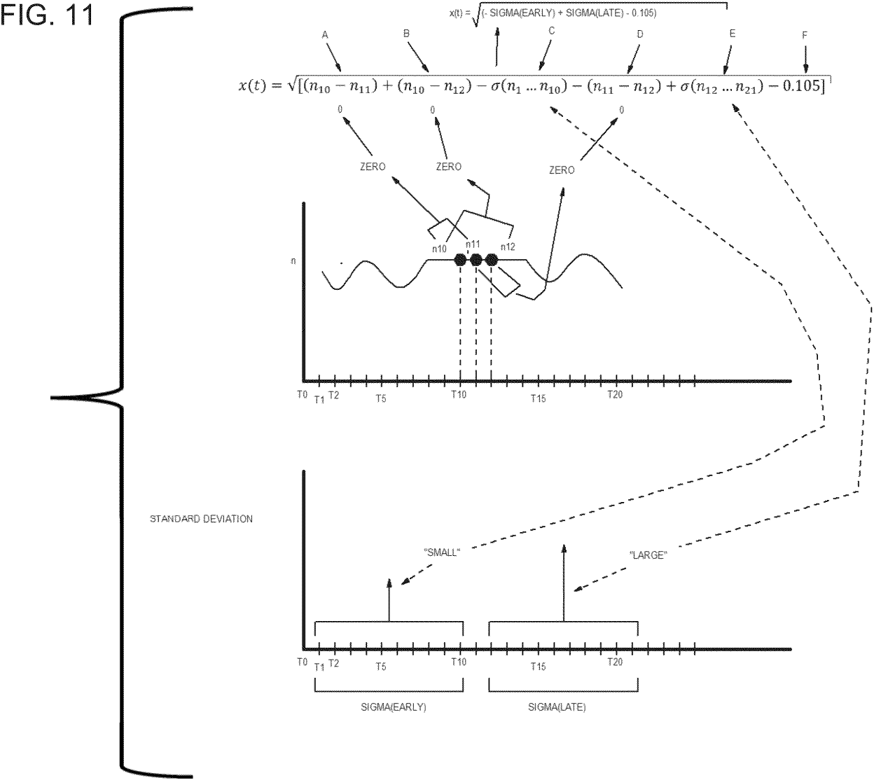

Standard deviation is one of many measures of the scatter of data. FIG. 8-8A illustrate three generalized plots of data, with their corresponding standard deviations which are labeled SD. The plot having a standard deviation, SD, of five is narrow, and is tall, indicating a large mean. The plot having SD of 20 is wide and short, indicating a wide scatter of data values, and a small mean. The plot having SD of ten is between the two others.

The standard deviations in equation 36 in FIG. 5, namely items C and E, have different signs. The standard deviation of the early pressures, that is, those before time T11, is given a negative sign. This standard deviation is labeled C. The standard deviation of the late pressures, that is, those after time T11, is given a positive sign. This standard deviation is labeled E. Considering these standard deviations in equation 36 in FIG. 5, and the graphs and plots shown in FIG. 8-8A, one can draw the following conclusions.

FIRST. If the early pressures are widely scattered with a small mean, then SIGMA(EARLY) will be large, analogous to SD20 in FIG. 8A. If the late pressures are similarly scattered, with a similar mean, then SIGMA(LATE) will equal SIGMA(EARLY). They will cancel each other because of their opposing signs. The value of equation 36 will then be determined by terms A, B, D, and F.

SECOND. If as in FIRST, the early pressures are widely scattered with a small mean, then SIGMA(EARLY) will be large, analogous to SD20 in FIG. 8A, but if the late pressures are close to each other, analogous to SD5 in FIG. 8A, then SIGMA(LATE) will be small. The sum of terms C and E in equation 36 in FIG. 5 will be resultantly negative. This determination will militate in favor of concluding that door 14 did not open, subject to the values of the other terms A, B, D, and F.

THIRD (OPPOSITE OF SECOND). If the early pressures are narrowly scattered with a large mean, then SIGMA(EARLY) will be small, analogous to SD5 in FIG. 8A. If the late pressures are widely scattered with a small mean, analogous to SD20 in FIG. 8A, then SIGMA(LATE) will be large. The sum of terms C and E in equation 36 in FIG. 5 will be positive as a result. That determination will militate in favor of concluding that door 14 did open, subject to the values of the other terms A, B, D, and F.

Term F is a correction factor, which can be determined empirically. For example, the door 14 can be repeatedly closed, perhaps by a robot arm or automatic opener (not shown). Equation 36 is solved for each closure event, but with a different correction factor F. Eventually, a factor F will be found where the bracketed term in equation 36 goes positive. That factor is then used. The correction factor is determined by measuring known door 14 openings events and determining the value needed to generate a positive value that can be used to signify a door 14 opening without creating false positives. The same equation is used for all events. The correct correction factor is the smallest value that gives the highest percent accuracy. The inventors have found that in controlled settings 100% accuracy can be obtained. The inventors envision that the correction factor might change in different environments. Currently, the only way this could be done is by either collecting data from known openings or possibly by carefully analyzing field data, however, it is not always clear if a door 14 was opened when the data is messy, so collecting data from controlled settings is preferred in one illustrative embodiment.

### EXAMPLES OF SEVERAL EMBODIMENTS

For ease of understanding the embodiment, system and method being described, the operation of the systems and methods will be described relative to several examples and illustrations. This discussion will consider examples of progressively more complex pressure distributions of the type shown in FIG. 5 in order to illustrate the operation of equation 36 and algorithm and the system and apparatus 10.

A primary aspect of equation 36 is as follows:

FIRST. If the bracketed quantity (that is the algebraic sum of terms A, B, C, D, E, and F) is negative, thus causing the square root to be imaginary, then it is concluded that door 14 in FIG. 1 has not been opened and has remained closed between T1 and T10.

SECOND. If the bracketed quantity is positive, thus causing the square root to be real, it is concluded that the door 14 in FIG. 1 opened at some time between T1 and T10.

THIRD. It is considered highly unlikely that the bracketed quantity will equal zero, so that case is not considered or can be considered indeterminate.

The following examples will facilitate understanding the embodiment being described.

### Example 1

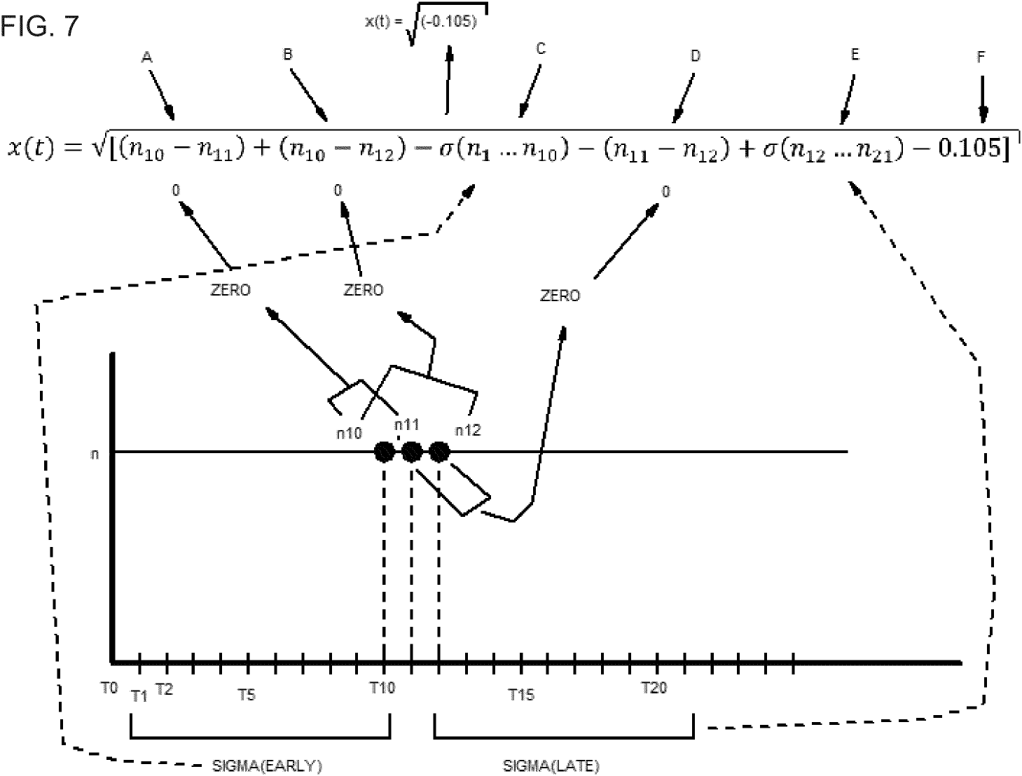

FIG. 7 shows a constant pressure n detected by the barometric pressure sensor 16 in FIG. 2. The equation 36 is shown above the pressure plot, with individual terms labeled A through F. The behavior of equation 36, when fed the pressure-data shown, is as follows.

Terms A, B, and D concern pressures n10, n11, and n12, which are all equal. Therefore, terms A, B, and D are zero.

Term C, the standard deviation for the ten pressures n1 - n10, and also called SIGMA(EARLY), is also zero: all pressures are the same. Term E, which is the standard deviation for the ten pressures n11 - n21 and also called SIGMA(LATE), is also zero because all pressures are the same.

The bracketed term in equation 36 will be negative 0.105, as indicated. It should be understood that the last term in one embodiment is 0.105, but this could vary and be selected based upon the environment. The term could vary between 0.1 and 0.12. It should be understood that the term and range can be different, such as 0.05 to 0.15, and it can possibly be broader. If an unusually high positive pressure is detected, then a larger adjustment might be required. Preferably, an experiment may be performed at several different positive pressures to determine if there may be a trend. It should be understood that the last term is computed based upon the specific parameters of the room 18 which can include, and are not limited to, the size of the room, a predetermined positive pressure in the room, the number of doors or windows in the room, ventilation level in the room and the like. These parameters all weigh into the computation of the last term. The square root of a negative number is imaginary. When the bracketed term is negative and an imaginary number is produced by equation 36, one form of the invention interprets that as indicating that door 14 has not opened during the period spanning from T1 to T10.

The constant pressure of FIG. 7 is interpreted as indicating a lack of a door 14 opening between times T1 and T10. Because there is no door 14 opening, no action needs to be taken.

### Example 2

FIG. 8 shows an arbitrary pressure waveform labeled PB in FIG. 8, running from times T1 through T10, followed by constant pressure. Terms A, B, D, and E in equation 36 are zero for the same reasons as in FIG. 7.

Term C, the standard deviation for the ten pressure readings taken from T1 through T10, has some value, indicated by arrow A1 in the bottom left part of FIG. 8. The bracketed term in equation 36 reduces to [-SIGMA(EARLY) - 0.105], wherein SIGMA(EARLY) is given a minus sign. That bracketed quantity is necessarily a negative number, resulting in an imaginary square root, thereby causing one embodiment of the invention to declare that the door 14 in FIG. 1 remained closed between times T1 and T10. One interpretation of the data is that a pressure wave occurred between times T1 and T10, followed by calmness. That is interpreted as a lack of door 14 opening between times T1 and T19.

### Example 3

In FIG. 9, another example is shown wherein an arbitrary pressure wave PB is illustrated and occurs between times T1 and T10, and another arbitrary pressure wave PC occurs between times T12 and T21. Pressure at times T10, T11, and T12 is constant.

If the standard deviations for both pressure waves are the same, as indicated, then terms C and E cancel each other. Equation 36 takes the square root of negative 0.105 and produces an imaginary number. The invention declares that the door 14 remained closed between times T1 and T10.

### Example 4

Same facts as in EXAMPLE 3, but as shown in FIG. 10, the standard deviation for the pressures for T1 through T10 is greater than the standard deviation for the pressures for T12 through T21. These are indicated by “large” and “small” in the standard deviation waveform at the bottom of FIG. 10 to note the difference.

The bracketed term becomes [-SIGMA(EARLY) + SIGMA(LATE) - 0.105]. This bracketed term is necessarily negative because, by stipulation, SIGMA(EARLY) is greater than SIGMA(LATE) and SIGMA(EARLY) is given a negative sign. Further, SIGMA(EARLY) is made further negative by the addition of negative 0.105 to it.

One embodiment of the invention declares that the door 14 remained closed between times T1 and T10.

### Example 5

Same facts as in Example 4, except that SIGMA(LATE) is now greater than SIGMA(EARLY) as illustrated in FIG. 11. The bracketed term is again [-SIGMA(EARLY) + SIGMA(LATE) - 0.105] as in EXAMPLE 4, but now the sign of the bracketed term depends on the relative sizes of the SIGMA=s. That is, the bracketed sum is the result of subtracting both [SIGMA(EARLY) and 0.105] from SIGMA(LATE). If the sum is negative, then one embodiment of the invention declares that the door 14 remained closed between times T1 and T10, as before.

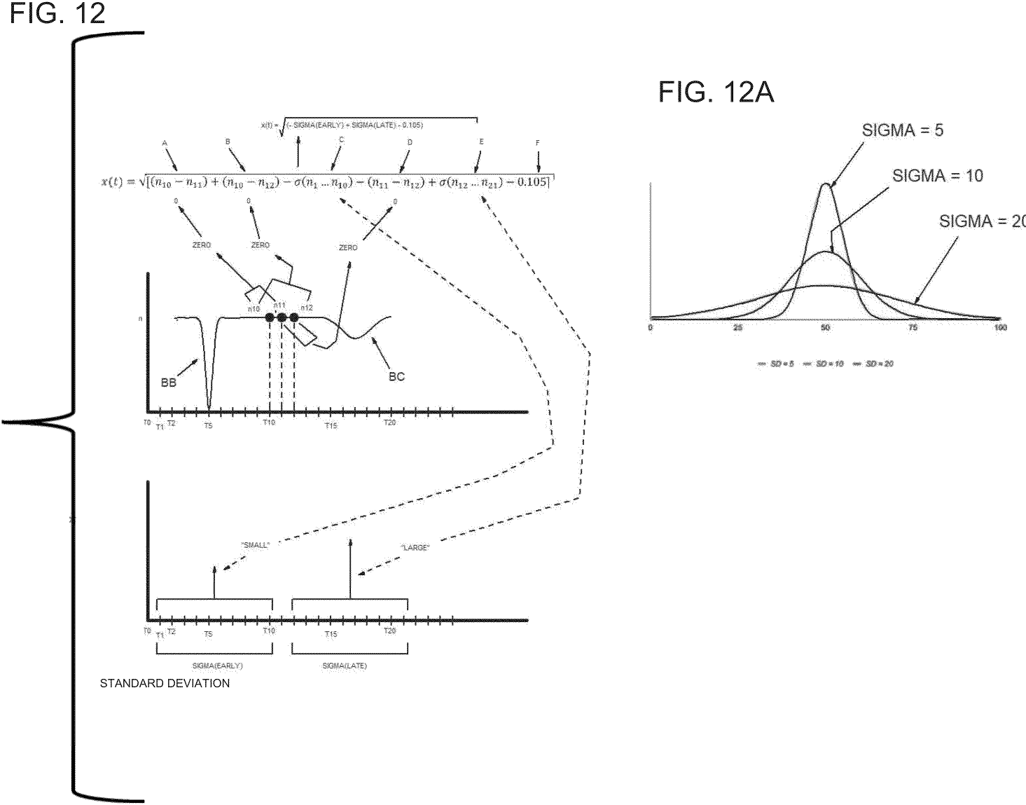

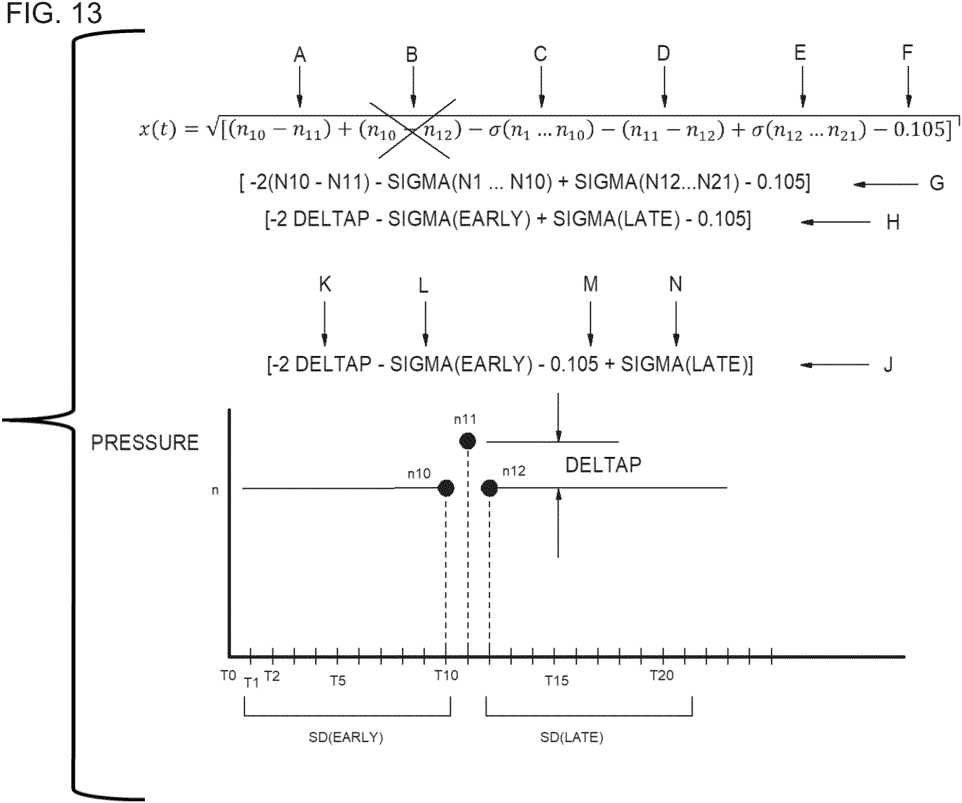

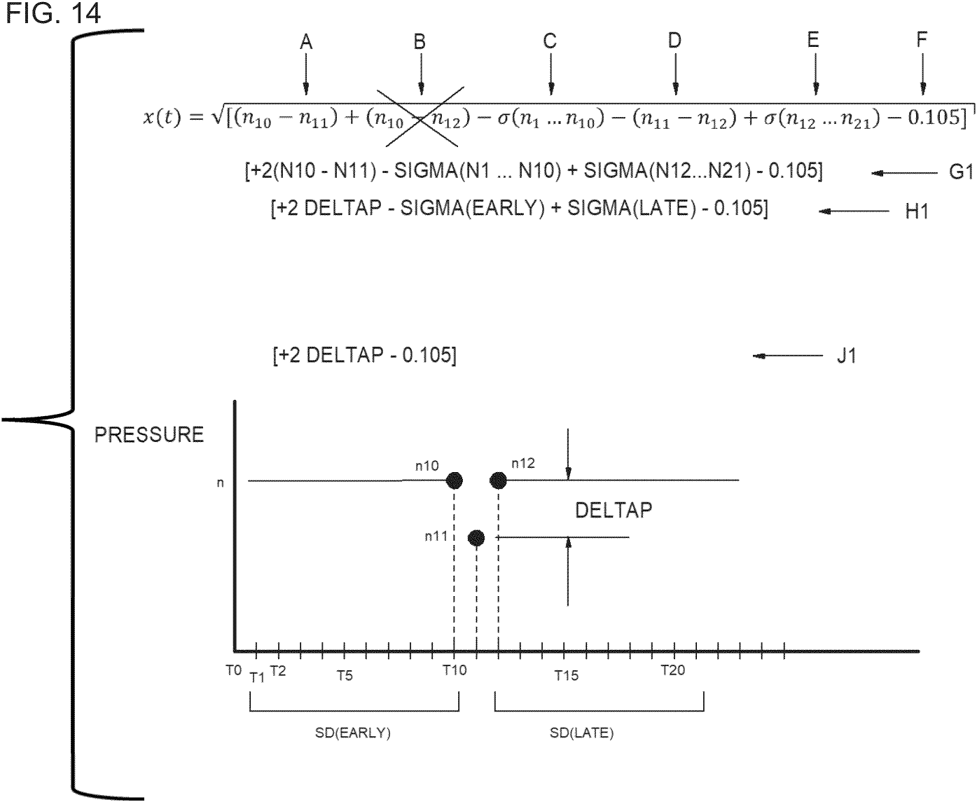

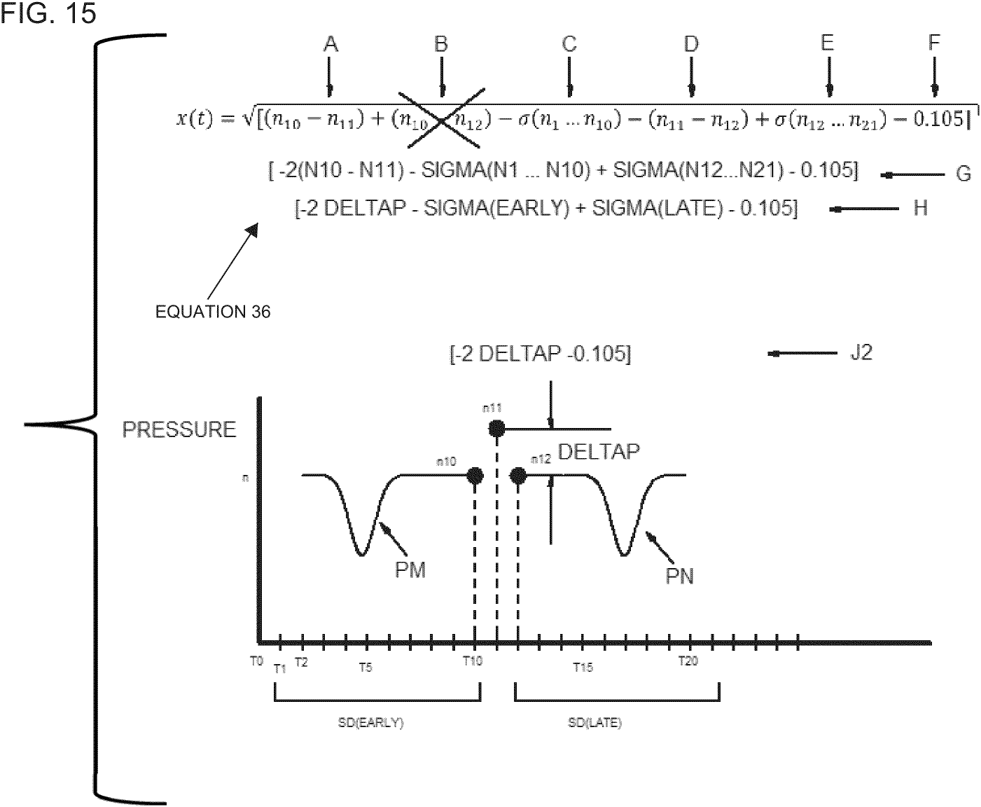

A simplified explanation of the physics underlying the situation can be given in connection with FIGS. 12 and 12A, which shows the arbitrary pressure waves PB and PC of FIG. 9 drawn as well-behaved bell curves BB and BC in FIG. 12.

A mathematical fact is shown in FIG. 12A. A “small” standard deviation, such as SIGMA=5 indicates that the corresponding data from which the SIGMA was computed is tightly grouped with a “large” mean. The mean is “large” because the “mouth” of the bell is relatively small, meaning that not many data points lie far from the mean. Such points would reduce the mean. For example, the data set 8, 8, 9, 9, 10 would have a mean of 8.8. The data set of 2, 2, 2, 9, 10 would have a mean of 5. The former data set is tightly grouped (the data points are not widely spread from the mean), with a larger mean. In contrast, the latter data set is spread out with a smaller mean.

In FIG. 12A, three standard deviations are shown: SIGMA = 5, SIGMA = 10, and SIGMA = 20. The bell-shaped wave BB running from T1 to T10 resembles SIGMA = 5. The bell-shaped wave BC (FIG. 12, top graph) running from T12 to T21 resembles SIGMA = 20. In this example, where SIGMA(EARLY) is less than SIGMA(LATE), the value of the bracketed term in equation 36 depends on the relative values of SIGMA(EARLY), SIGMA(LATE), and the constant (negative 0.105).

In general, if bell-wave BB is a narrow pressure pulse in time (i.e., SIGMA(EARLY) is “small”), followed by a shallow, wide pressure pulse BC (i.e., SIGMA(LATE) is “large”), then subtracting both [SIGMA(EARLY) and 0.105] from SIGMA(LATE) can produce a positive number. In this instance, one embodiment of the invention would declare that door 14 opened between times T1 and T10.

### Example 6

In FIG. 13, assume that pressures n10, n11, and n12 are pulses of pressure as shown. Pressure n11 is a pulse, deviating by DELTAP from both n10 and n12, as indicated. This makes term B equal zero because n10 equals n12. Pressure is constant elsewhere.

The value within the parentheses of term A will equal the value within the parentheses of term D (because both equal DELTAP), but term A will be negative (because n11 is greater than n10) and term D is assigned a negative sign.

So, the expression within brackets can be re-written as expression G, which is illustrated underneath the equation x(t) at the top of FIG. 13. In expression H, “DELTAP” replaces the first term in expression G. Expression H can be re-ordered as in expression J (shown underneath expression H in FIG. 13). Note that the first three terms in expression J have negative signs and the last term is positive. It is noted that standard deviation SD is always positive.

FIG. 12A indicates three types of normal distribution. A tall, narrow distribution has a “small” standard deviation SD. A wide, short distribution has a “large” standard deviation SD.

If SD(EARLY) equals SD(LATE), then terms L and N in expression J in FIG. 13 cancel each other. Therefore, expression J will be negative and a declaration of no door 14 opening will be issued in one embodiment.

However, if SD(LATE) is sufficiently large (i.e., the pressure distribution at times T12 - T21 is “short” and “wide,”) then term N in expression J can dominate, making the expression positive and result in a declaration of opening the door 14.

It should be understood that the term N is detected and recorded every second in one embodiment using the following equation to analyze a series of sequentially recorded data:

$$\begin{matrix}x \left(t\right) = \\ √ \left[\left({n}_{10} - {n}_{11}\right) + \left({n}_{10} + {n}_{11}\right) - σ \left({n}_{1} … {n}_{10}\right) - \left({n}_{11} - {n}_{12}\right) + σ \left({n}_{12} … {n}_{21}\right) - 0.105\right]\end{matrix}$$

where nt is the barometric pressure at time, t, σ is the standard deviation of the specified range and x is a real number or an imaginary number (square root of a negative number) and indicates whether or not a door 14 opening event has occurred or has likely occurred within the time range of t to t + 1 s, and up to a range of t to t + 10 s. When x is a positive number, a door 14 opening event has occurred. When x is an imaginary number a door 14 opening did not occur or very likely did not occur. This equation could also be written as x(t) = √[(J - K) + (J - L) - σ(A ...J) - (K - L) + σ(L ... U) - 0.105] where A... U are the barometric pressure values at time t.

In one embodiment, the door 14 opening events are counted and based upon the output derived from the equation 36 including counting the number of data points in a data set where the outputs are greater than zero as derived from the equation.

In one embodiment, the number of data points in a data set where outputs are values greater than zero are derived and a value indicating a door 14 opening event.

### Example 7

If DELTAP is a negative blip, as in FIG. 14, then terms A and D become positive terms and expression G1 (shown underneath the equation in FIG. 14) results. In FIG. 14, both SD(EARLY) and SD(LATE) equal zero, resulting in expression H1, and thence J1, similar to the analysis in FIG. 13. Declaration of a door 14 opening will depend on the size of 2 DELTAP versus -0.105. If DELTAP is less than 0.105/2, no door 14 will be declared because expression J1 (FIG. 14) will be negative.

On the other hand, if the negative blip (that is, DELTAP) is large, a door 14 opening will be declared.

### Example 8

FIG. 15 resembles FIG. 13, but with pulses PM and PN added. If the standard deviations of both pulses PM and PN are equal, then SD(EARLY) cancels SD(LATE) in expression H, and expression J2 (FIG. 15) results. Expression J2 is negative, so one embodiment of the invention treats the door 14 as not being opened.

### Example 9

FIG. 16 resembles FIG. 13, but with pulses PM1 and PN1 added.

The decision on whether to declare a door 14 opening will depend on the algebraic sign of expression H. If SIGMA(LATE) dominates, making the expression H positive, then the door 14 is declared to have opened.

### Example 10

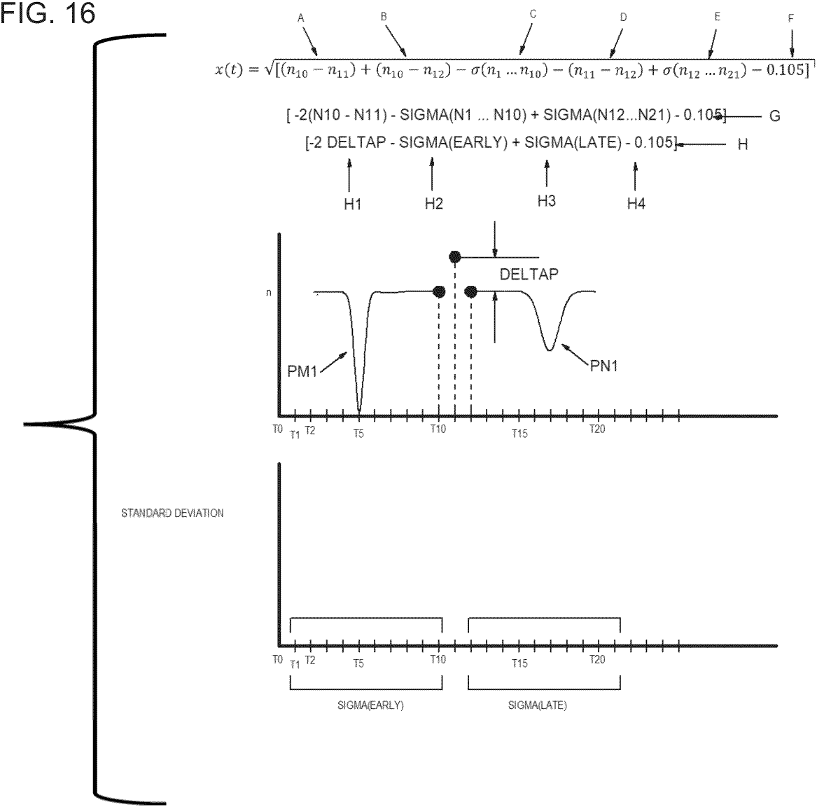

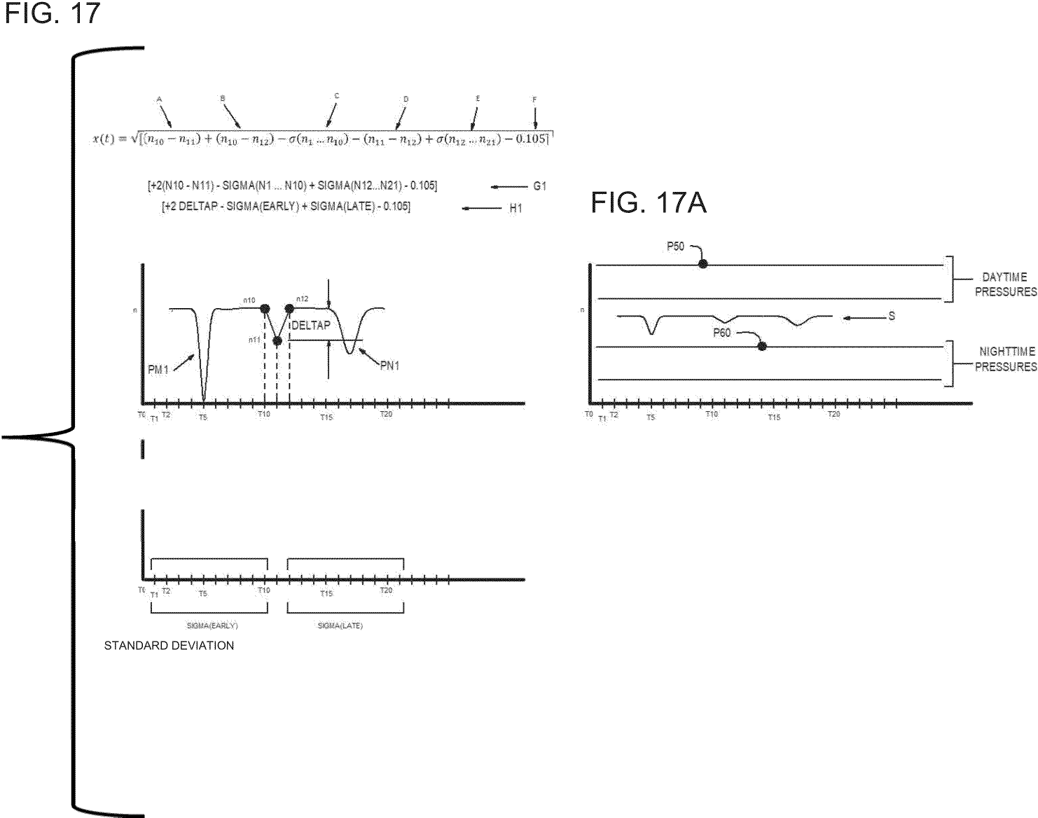

FIG. 17 resembles FIG. 14, but with pulses PM1 and PN1 added. The bracketed expression in equation 36 can be rewritten as expression H1. The term 2DELTAP and the term SD(LATE) tend to drive expression H1 positive, leading to a declaration of a door 14 opening. Only if the term SD(EARLY) and the term -0.105 can overcome that will the declaration be avoided.

### Additional Examples

FIG. 18A shows the pressure values n10, n11, and n12 of FIG. 5. The value at time T11, namely, n11, can be referred to as a central, or median, value, since ten other values occur after it (namely, those at T12 through T21 in FIG. 5) and ten other values occur before it (those at T1 through T10 in FIG. 5). FIGS. 18A through 18E show five possible inter-relationships between pressures n10, n11, and n12, to provide a qualitative explanation of how those relationships affect the terms A, B, and D factors in the equation and thus how the inter-relationships affect the bracketed term in equation 36.

The left side of each FIGS. 18A through 18E shows the three algebraic sums of the terms labeled A, B, and D in FIG. 5. Those terms are differences between the pressures n10, n11, and n12 as shown in FIGS. 18A-18E. The units are arbitrary because the purpose is to show generalized results of each combination of FIGS. 18A through 18E.

In FIG. 18A, n12 is greater than n11 and n11 is greater than n10.

FIG. 18B is like FIG. 18A, except that in FIG. 18B, n12 is less than n11, but greater than n10.

FIG. 18C is like FIG. 18B, except that in FIG. 18C, n12 is less than n11, and also less than n10.

In FIG. 18D, n12 is less than n11, and n11 is less than n10.

FIG. 18E is like FIG. 18D, except that in FIG. 18E, n12 is greater than n11, but less than n10.

In FIG. 18A, the sum labeled A equals negative 2 units because the graphical distance between n11 and n10 is two units. The sum is negative because term A requires n11 to be subtracted from n10, and in this case, n11 is larger than n10. The same comment applies to the rest of FIGS. 18B-18E.

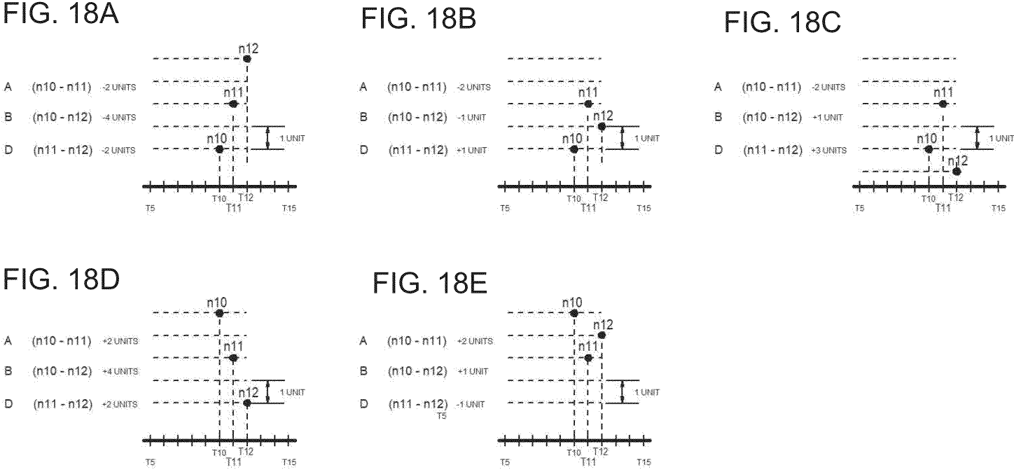

FIG. 19 shows five copies of equation 36. The sums A, B, and D of each of FIGS. 18A through 18E are copied at the right side of FIG. 19 and labeled to correspond to the FIGS. 18A-18E as shown and for ease of illustration and description. Each term A, B, and D is labeled in each of the five copies of equation 36. Adjacent each term is a value taken from a copy such as FIG. 18A. The net influence of the terms is written adjacent to or above the equation 36 as shown in FIG. 19. For example, in FIG. 19, the section labeled “FIG. 18A” contains values for A, B, and D of -2, -4, and -2, respectively. Three dashed arrows show how those values are inserted into equation 36. The net effect of those three values is negative 4, which is written to the left side of the equation underneath the part number 36 in the FIG. 19, which identifies equation 36. This is repeated for the five illustrations 18A through 18E.

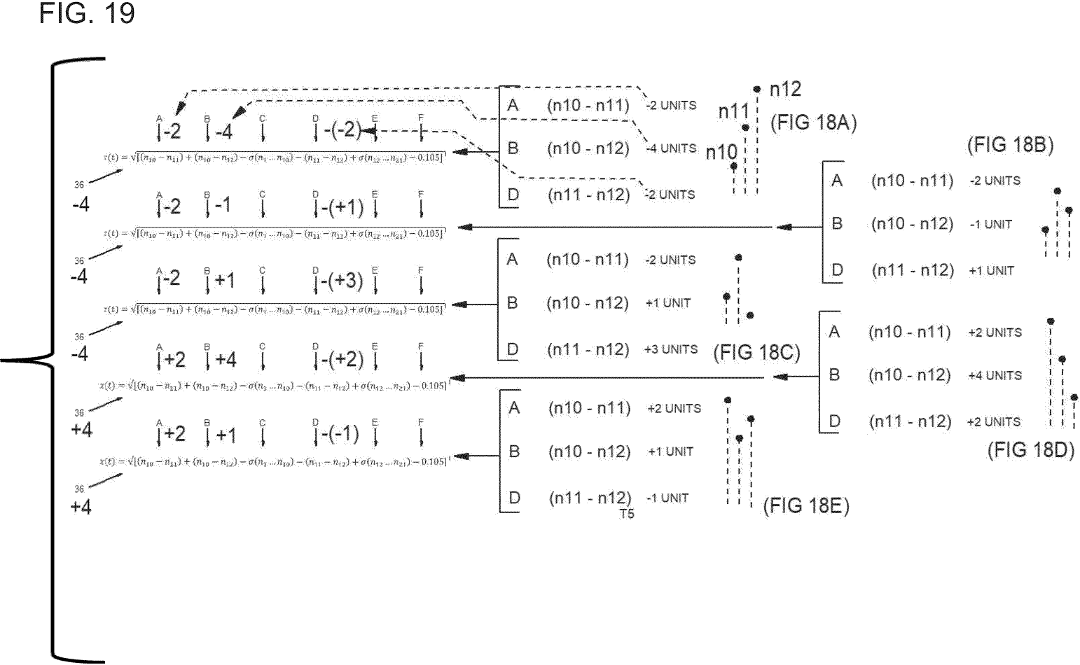

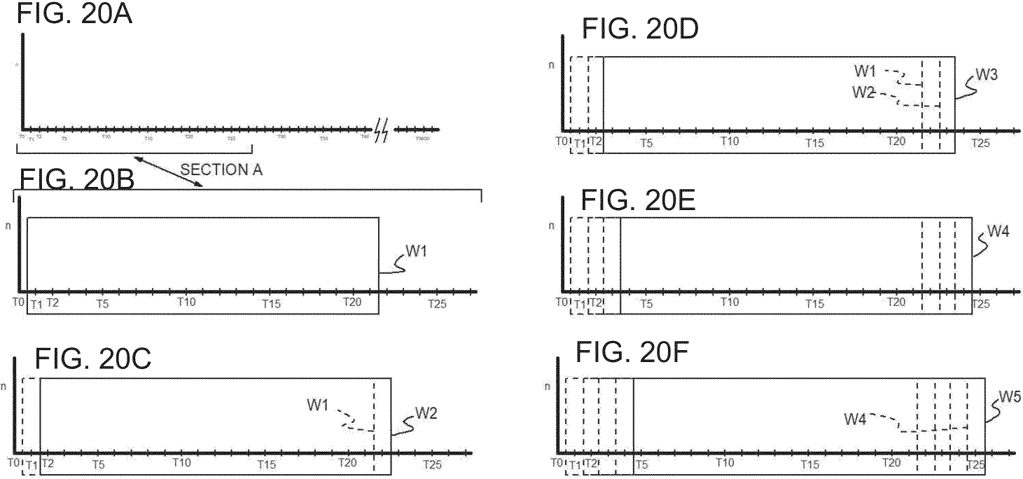

The preceding discussion has considered processing of the data of the type shown in FIG. 5, which contains 21 data points. However, in practice, a longer sequence of data is used, such as that shown in FIG. 3. FIG. 20A shows a copy of FIG. 3. Section A of FIG. 20A is also shown enlarged in FIG. 20B. Section A corresponds to the section running from T1 to T21 in FIG. 5. The pressures running from T1 to T21 are processed as described above.

During operation, the window of data values, which is labeled W1 in FIG. 20B, is conceptually shifted or moved to the position shown in FIG. 20C. But now the first pressure is that at T2 (FIG. 20C) and the last pressure is that at T22, but the processing is the same as discussed relative to FIG. 5.

Next, the window is shifted or moved to W3 in FIG. 20D, and T3 in FIG. 20D becomes T1 in FIG. 5 and T23 becomes T21 in FIG. 5.

Next, the window is shifted or moved to W4 in FIG. 20E, and T4 in FIG. 20E becomes T1 in FIG. 5 and T24 becomes T21 in FIG. 5.

Next, the window is shifted or moved to W5 in FIG. 20F, and T5 in FIG. 20F becomes T1 in FIG. 5 and T25 becomes T21 in FIG. 5, and so on.

Thus, it should be appreciated that the data processor 20a utilizes the equation 36 from memory or storage 20b and is adapted to apply it on a moving temporal baseline or moving frame substantially illustrated in FIGS. 20A-20F. The moving frame is adapted to isolate discrete, short-term pressure deviation events which occur from the door 14 opening in the room 18 to possibly experience a change from a positive pressure environment to a lower pressure environment. Advantageously, the temporal frame and deviation as calculated as described herein are provided in a data packet. Essentially, the process and algorithm travels along sets of data to do the calculation, moving the frame 1 second at a time. Note that the frame is isolating the deviation events that are large enough relative to the standard deviation within that moment in time. The transformed data shows a single spike (illustrated in FIG. 21). If nothing “noteworthy”, such as a large spike, then the equation gives an error (square root of negative number), which can be considered 0 for data counting purposes. A Microsoft Excel® function is used which tells the program to count all calculated numbers greater than 0, so where there is an error, nothing will be counted.

It should be understood that the system, method and apparatus 10 and processor 20a may provide amplification of the deviation events and/or data packets. The data is amplified by transformation into a positive spike. All values around the spike are zero if a door 14 is not opened. There may be other ways to amplify the data, such as squaring it, although this probably isn’t necessary. It should be understood that the computation system and apparatus 20 and processor 20a causes the data associated with the processed deviation events to be transformed into discrete data points representing door 14 openings. The equation 36 transforms the raw data into either errors or positive numbers. The Microsoft Excel® “COUNTIF” function then counts the number of instances of a positive number. When graphed, the deviations are transformed into spikes (see FIG. 21). It should be understood that everything may be calculated automatically by the software in the air cleaning and disinfection device 30, such as the ILLUVIA® Sense and AEROSCOPE™, which are stand-alone sensing devices without the air cleaning component with similar sensors, both of which are available from Aerobiotix, LLC located in Miamisburg, Ohio. In some embodiments, the deviations within the data packets are compared to a predetermined threshold level. In some instances, spikes with low values might be identified as false positives. It might be possible to use spike magnitude rather than changing the correction factor if there are too many false positives in some situations. To do this, the Microsoft Excel® “COUNTIF” function can be changed from >0 to >X where x is whatever is a positive number determined to work to identify spikes, an example would be COUNTIF X>0.015. For those events identified within the data packet having a deviation greater or exceeding the predetermined threshold level are recorded in the computation system and apparatus 20, for example, in the memory or storage 20b. Thereafter, the events identified in the packets which exceed the predetermined threshold level are identified as spikes that have a value greater than some value determined as the threshold. For example, maybe it is found that spikes with values equal to or less than 0.01 are false positives. In this case, only spikes with values greater than 0.01 are counted as real door 14 openings.

In this manner, successive groups of 21 pressure measurements may be processed. Alternatively, the equation 36 may be elongated to consider more or fewer data points as desired. In short, the embodiments may be adapted to consider more or fewer data points.

### ADDITIONAL CONSIDERATIONS

1. Each term A, B and D in FIG. 5 can be viewed as a type of vector. Each has a magnitude because it is a difference between two pressures. Each also has direction in having a positive or negative algebraic sign. The sign may be viewed as indicating either an increasing or decreasing pressure. Therefore, in equation 36 in FIG. 5, the summation of terms A, B, and D can be viewed as a vector summation which indicates the overall trending of the three terms A, B, and C. FIG. 19, left side, provides an example of such trending. One trend is indicated as the positive number 4 and another trend is the negative number 4, as illustrated on the left side of the FIG. 19.

2. It may not be necessary to compute term D in FIG. 5 from pressure measurements. Term D may be derivable from terms A and B because that term A is (n10 - n11) and Term B is (n10 - n12). If one subtracts A from B, one obtains (n10 -n12) - (n10 - n11) = n10 - n12 - n10 + n11 = n11 - n12. The last pair is term B in FIG. 5.

3. It is to be understood that one embodiment of the invention eliminates any need for calibration based on variations on outdoor atmospheric pressure. For example, FIG. 17A shows a type of pressure signal S. Assume that a prior art detection system, different from those of the present invention, merely responded to a pulse in the pressure signal to infer opening of a door 14 or the door 14 had a trip sensor to indicate it was opened. However, atmospheric pressure changes naturally during the day. It may range between the limits labeled “daytime pressure” during the day and between the limits labeled “nighttime pressure” at night, as illustrated in the FIG. 17A. So, the mere passage of time, as from night to day, may simulate the pulse which is interpreted as an opening of a door. That is, pressure may change from P50 (FIG. 17A) at 10 am to P60 at 10 pm and that natural pressure swing may be sufficient to be detected as a pressure pulse or a false positive of a door 14 opening event. This was a problem of the prior art that the present embodiments overcome.

Restated as a numerical example, the pressure pulse indicating the door 14 opening may be 10 percent of the swing from P50 to P60. Given that fact, the swing from P50 to P60 will be detected incorrectly as the pressure pulse caused by a door 14 opening. In contrast, the embodiments of the invention base its decisions solely on the pressure data recorded between T1 and T21.

4. A pressure sequence detected by barometric pressure sensor 16 (FIG. 2) may be different for the same person passing through the same door 14, but in the opposite direction. One reason would be that the door 14 may swing in only a single direction, so that a person may pass through the door 14 in one direction without stopping by merely pushing it open. But, to pass through in the other direction, the person must (1) approach the door 14, (2) grasp it or cause it to open, (3) step backward to allow the door 14 to open that person’s own space and then (4) step through the now-opened door 14. Clearly, this latter process is more time-consuming than the former process.

Other signatures will be obtained for different events, such as a pair of nurses wheeling a gurney through the door 14 in order to enter the hospital operating room.

5. In one form of the invention, the sequence of pressures n1 through n21 in FIG. 5 is divided into three segments: (1) n1 through n9, (2) n10 through n12, and (3) n13 through n21. The invention develops a figure of merit for each segment. For segment (1), the figure-of-merit can be SIGMA(EARLY). For segment (2), an algebraic sum of the three pressures n10, n11, and n12. For segment (3), SIGMA(LATE). The invention compares the three figures-of-merit with a predetermined criterion to deduce whether the door 14 has opened.

6. Advantageously, the system, process and method described herein provide means and apparatus for transforming barometric pressure data into an output 62 that counts door 14 opening events. A report is generated that tells personnel, such as a doctor or the operating room manager, the number of door 14 openings within a surgical period. The operating room manager may then use the information to determine if improvement is needed regarding the number of times a door 14 is opened during surgery. The reports may include number of door 14 openings, CO₂ level, particle counts, VOC level, etc. The number of door 14 openings is one factor that can contribute to increased surgical site infection using the reports and data can reduce contamination in the room 18, thereby resulting in decreased levels of patient infections.

7. In one embodiment, the system 10 isolates relatively large pressure changes deduced by door 14 openings and natural variations in barometric pressure so that door 14 opening events can be distinguished. The door 14 opening is determined by the large discrete changes in pressure. The large pressure changes are isolated from natural variations by analyzing the standard deviation as is done in equation 36. The inventors have currently not found a way to do a simple subtraction pressure at time T2 minus pressure at time T1. If there might be some situations where excessively high positive pressure is sensed for example, where a more simplified equation can be used such as simply subtracting data point two from data point 1. Equation 36 and the process or system 10 is designed to isolate large pressure changes from natural variations

8. It should be understood that the system, process and method 10 described herein may be applied to any enclosed space under positive pressure, not just the operating room 18. It could be another room in the medical facility or in a room in a non-medical facility. In short, it could be applied to any enclosed space having a door.

9. Advantageously, the system, process and method 10 transform pressure data, especially a set of pressure loss data associated with a door 14 opening event into a single point associated with that event. “Single point” means a spike (see FIG. 21). The spike is associated with one second in time. While the raw data for the door 14 opening extends over several seconds (about 10 seconds in the inventor’s controlled experiments), the equation takes this packet of data and makes a single data point that is easy to distinguish with either a “zero” or a spike with a positive value.

10. Advantageously, the system, process and method can record pressure data every second for a period of time, such as ten seconds, which could be longer or shorter if desired. Also, more or fewer pressure data readings may be taken.

11. The computation system and apparatus 20 may comprise a curve-flattening and/or noise reduction means or algorithm to remove variations from normal environmental and atmospheric changes in barometric pressure to provide a “de-noising” means or apparatus that may be applied to the data. This may be in the form of a filtration, averaging, wave transforming, de-noising algorithms or similar processes. This could be taking the derivative, the square root, the moving average, or the like. There are a variety of mathematical functions that someone skilled in the art might use. One thing that may be done with the data is averaging each point.

12. As mentioned earlier, once the door 14 openings are identified in the manner described herein, the packet associated with that door 14 opening is stored in memory 20b of the computation system and apparatus 20 which is either resident on the air cleaning and disinfection device 30 or on a remote server 32, for example, so that reporting and alarm can be associated with such door 14 opening. In this regard, either the remote server 32 or the air cleaning and disinfection device 30 may comprise an electronic reporting and alarm 34 which may be used to automatically or manually perform an action, such as turning on a blower of a HVAC unit to increase the pressure in the room 18. Primarily, one goal of these embodiments is to collect and report the data and use it to detect door 14 openings. Other activities could be performed by the system 10, such as energizing an alarm 34 or increasing the HVAC pressure in the room 18. It may not be practical in an operating room to increase the positive pressure because once the door 14 is open it may take a seemingly excessive amount of positive pressure to maintain positive pressure. In a preferred embodiment, the goal is to generate daily reports and track door 14 openings over time. This might help uncover surgical site infection risk factors. For example, it would be advantageous to know when calculated door 14 openings are above a certain threshold, the chance of surgical site infection increases significantly.

It should be appreciated that the system, method and apparatus 10 may also be used to determine deviations within sets of an upstream and/or downstream distant sets, creating a blended value of deviation s, via averaging via mean, median, mode, range or similar means. Using this method means using average values for the standard deviation that is determined by studying variations in barometric pressure with the door 14 closed and never opened. The analysis could also involve calculating the standard deviation every 10 seconds (or possibly some other amount of time). The standard deviations would then be averaged. The median and mode could also be calculated. It would then need to be determined through controlled experiments whether or not this approach is more useful than calculating the standard deviation as the frame moves in equation 36.

It should be understood that numerous substitutions and modifications can be undertaken without departing from the true spirit and scope of the present invention. What is desired to be secured by Letters Patent is the invention as defined in the following claims.

Advantageously, another embodiment of this invention, including all embodiments shown and described herein, could be used alone or together and/or in combination with one or more of the features covered by one or more of the claims set forth herein, including but not limited to one or more of the features or steps mentioned in the Summary of the Invention and the claims.

While the system, apparatus and method herein described constitute preferred embodiments of this invention, it is to be understood that the invention is not limited to this precise system, apparatus and method, and that changes may be made therein without departing from the scope of the invention which is defined in the appended claims.

what is claimed is:

1. A method to track door openings comprising the steps of:
using a barometric pressure sensor;
performing electronic data collection of pressure readings as a function of time;
processing and analyzing the data to ascertain door opening events;
applying an equation to transform the data to facilitate identification of door opening events; and
applying a program to automatically count a number of door openings based on the transformed data.

2. The method as recited in claim 1, wherein said method further comprises the step of:
using a barometric pressure sensor, including a MEMs-based barometric pressure sensor, to monitor door openings.

3. The method as recited in claim 1, wherein said method further comprises the step of:
interfacing technology with an air cleaning and disinfecting device.

4. The method as recited in claim 1, wherein said method further comprises the step of:
using a barometric pressure sensor to monitor door openings in an operating room setting.

5. The method as recited in claim 1, wherein said method further comprises the step of:
locating a door monitoring system in a position that is not in contact with a door in the room or placed between the door and door frame.

6. The method as recited in claim 1, wherein said method further comprises the step of:
using a pressure sensor in the periphery of a room, including an operating room, to monitor door openings via detected changes in pressure upon opening the door.

7. The method as recited in claim 1, wherein said method further comprises the step of:
mathematically transforming barometric pressure data to facilitate the identification of door opening events.

8. The method as recited in claim 1, wherein said method further comprises the steps of:
calculating barometric pressure changes over time; and
comparing with the standard deviation of the barometric pressure over time to identify door opening events.

9. The method as recited in claim 1, wherein said method further comprises the step of:
analyzing barometric pressure data several seconds before and several seconds after a specific time parameter in order to identify whether or not a door opening event occurred within the time-frame of the time parameter including 10 seconds before or after the time parameter.

10. The method as recited in claim 1, wherein if barometric pressure, n, is detected and recorded every second, said method further comprises the step of:
using the following equation to analyze a series of sequentially recorded data,
$$\begin{matrix}x \left(t\right) = √ \left[\left({n}_{10} - {n}_{11}\right) + \left({n}_{10} - {n}_{12}\right) - σ \left({n}_{1} … {n}_{10}\right) - \left({n}_{11} - {n}_{12}\right) +\right) \\ \left(σ \left({n}_{12} … {n}_{21}\right) - 0.105\right]\end{matrix}$$
where nt is the barometric pressure at time, t, σ is the standard deviation of the specified range and x is a real number or an imaginary number (square root of a negative number) and indicates whether or not a door opening event has occurred or has likely occurred within the time range of t to t + 1 s, and up to a range of t to t + 10 s;
when x is a positive number, a door opening event has occurred;
when x is a positive number, a door opening event is likely to have occurred;
when x is an imaginary number a door opening did not occur or very likely did not occur;
said equation also being written as
$$\begin{matrix}x \left(t\right) = \\ √ \left[\left(J - K\right) + \left(J - L\right) - σ \left(A … J\right) - \left(K - L\right) + σ \left(L … U\right) -\right) \left(0.105\right]\end{matrix}$$
where A...U are the barometric pressure values at time t.

11. The method as recited in claim 10, wherein said method further comprises the step of:
using a programming function to count door openings based on output derived from the equation, including counting the number of data points in a data set where outputs are values greater than zero as derived from the equation.

12. The method as recited in claim 10, wherein said method further comprises the step of:
incorporating the application of the equation and automated counting in a pressure sensing device.

13. The method as recited in claim 10, wherein said method further comprises the step of:
incorporating a pressure sensor, the application of the equation and automated counting in an air monitoring device.

14. The method as recited in claim 10, wherein said method further comprises the step of:
incorporating a pressure sensor, the application of the equation and automated counting in an air cleaning device.

15. The method as recited in claim 10, wherein said method further comprises the step of:
transforming barometric pressure data into an output that counts door opening events.

16. The method as recited in claim 10, wherein said method further comprises the step of:
isolating relatively large pressure changes induced by door openings from natural variations in barometric pressure so that door opening events can be distinguished.

17. The method as recited in claim 10, wherein said method further comprises the step of:
monitoring door openings by analyzing barometric pressure changes in operating rooms under positive pressure.

18. The method as recited in claim 10 wherein automated electronic output of door openings is based on the equation.

19. The method as recited in claim 10, wherein in said equation the last term (0.105) is varied between 0.1 and 0.12.

20. The method as recited in claim 10, wherein in said equation the last term is computed based on room specific parameters which can include, and are not limited to, size, positive pressure, number of doors and ventilation level.

21. The method as recited in claim 1, wherein said method may be applied to any enclosed space under positive pressure.

22. The method as recited in claim 1, wherein said method may be applied to any enclosed space with a door attached to a hinge.

23. The method as recited in claim 1, wherein said method further comprises the step of:
transforming a set of pressure loss data associated with a door opening event into a single point associated with said event.

24. A door opening tracking system for positive pressure rooms comprising:
a continuous barometric pressure sensor;
an electronic data processing system comprising a noise reduction means;
calculation of a temporally based data packet comprising a moving pressure data baseline and a discrete pressure event or spike, a spike threshold determination, and a data storage and retrieval means.

25. The door opening tracking system of claim 24 wherein the barometric pressure sensor comprises a sensor that detects atmospheres pressure via piezo-resistive, capacitance, deposition, wire, mechanical or equivalent means to generate an electrical signal on a continuous basis.

26. The door opening tracking system of claim 25 wherein transmitting and/or recording pressure data occurs every 10 seconds or less.

27. The door opening tracking system of claim 26 wherein said electronic data processing system comprises data input from said pressure sensor, processing of said data, output of said data to a data storage and retrieval system.

28. The door opening tracking system of claim 26 wherein said data processing comprising curve flattening and/or noise reduction to remove variations from normal environmental and atmospheric changes in barometric pressure;
said processing comprising a denoising means such as filtration, averaging, wave transformation, denoising algorithm or similar process.

29. The door opening tracking system of claim 26 wherein said data processing further comprising a moving temporal baseline or moving frame means to isolate discrete, shot term pressure deviation events which occur from door opening from a positive pressure environment to a lower pressure environment;
said temporal frame and said deviation comprising a data packet.

30. The door opening tracking system of claim 26 wherein said data processing comprises an amplification of deviation events and/or packets.

31. The door opening tracking system of claim 26 wherein said data processing system, wherein processed deviation events are transformed into discrete data points representing said door openings.

32. The door opening tracking system of claim 26 wherein deviations within said packets are compared to a predetermined threshold level.

33. The door opening tracking system of claim 26 wherein said events which exceed a predetermined threshold level are recorded in a data storage and retrieval system.

34. A method for identification of door openings in a positive pressure operating room comprising:
pressure sensing creating a continuous data stream;
creating at least one data packet consisting of a set of pressure values over a predetermined period of time;
entering said data packet into the data memory of a data processing device; and
electronic reporting of said door openings.

35. The method as recited in claim 34, wherein said data packet comprises:
a central value in the substantial midpoint of said packet;
an upstream proximate value occurring shortly before the central value;
a downstream proximate value occurring shortly after the central value;
a set of upstream distant values occurring prior to said upstream adjacent value; and
a set of downstream distant values occurring after said downstream adjacent value.

36. The method as recited in claim 35, wherein said method compares said central value with upstream and/or downstream proximate values and calculates a central deviation.

37. The method as recited in claim 36, wherein said method further comprises the step of:
determining deviations within sets of said upstream and/or downstream distant sets, creating a blended value of deviation s, via averaging via mean, median, mode, range or similar means.

38. The method as recited in claim 36, wherein said method further comprises the step of:
comparing said central value deviation with a common value of distant deviations, creating a central deviation set.

39. The method as recited in claim 36, wherein said central deviation set undergoes a filtration function to remove upward pressure deviations to create a filtered set.

40. The method as recited in claim 39, wherein said filtered set results in discrete spike values at recorded time points, the nonzero points and their associated times output into a data recording and/or transmission system.

41. The method as recited in claim 40, wherein said filtered set results in discrete spike values at recorded time points, of greater spike deviation than a predetermined threshold;
said spike values and their associated times points into a data recording and/or transmission system.

42. The method as recited in claim 40, wherein a data reading frame advances one discrete sensor data value after the calculation of said spike values, creating a new data packet with a central value at the previous downstream proximate value to create a substantially continuous moving packet frame.

43. A method of detecting opening of a portal in a pressurized room, comprising:
a) measuring a sequence of barometric pressures at a fixed location within the room; and
b) based solely upon pressures within the sequence, identifying a sub-sequence during which the portal had opened.

44. A method of detecting opening of a portal in a pressurized room, comprising:
a) generating a history of barometric pressures at a fixed location within the room; and
b) using the history and no other data, ascertaining whether the portal had opened.

45. A method, comprising:
a) obtaining data on barometric pressure within a room over a span of time;
b) ascertaining whether sections of the data meet predetermined criteria; and
c) if so, issuing a signal indicating that a portal in the room has opened during the span of time.

46. A system for a pressurized room in which (A) barometric pressure varies daily between a maximum Pmax and a minimum Pmin, and (B) opening a portal in the room causes a pressure disturbance Pd which is less than 10 percent of (Pmax - Pmin), comprising:
a) a recording system for producing a record of the barometric pressure within the room over a span of time, and
b) an analyzing system for detecting a pressure pattern indicative of an open portal in a wall of the room and, in response, issuing a portal-open signal.

47. The system according to claim 46 in which the analyzing system detects the pressure pattern without reference to any data outside the record.

48. A method for measuring changes in barometric pressure at a predetermined location after a door opens, said method comprising the steps of:
a) measuring barometric pressure at the location at different times, and
b) if measured barometric pressures meet predetermined criteria, generating a signal indicating that the door has opened.

49. An apparatus for a room having a portal which opens and closes, comprising:
a) within the room, a non-moving pressure sensor at a fixed location, which produces a history of barometric pressure in the room, said history containing (1) an early interval, (2) a middle interval, and (3) a late interval,
b) a processor which derives a figure-of-merit for each interval and, based on the figures-of-merit, concludes whether the portal has opened during one of the intervals.

50. A method of detecting opening of a portal in a pressurized room, comprising:
a) generating a history of barometric pressures at a fixed location within the room;
b) identifying midpoint T11 of the history;
c) deriving an indicator IN1of amount of scatter of pressures occurring before the midpoint;
d) deriving an indicator IN2 of amount of scatter of pressures occurring after the midpoint;
e) computing pressure drop A immediately preceding T11;
f) computing pressure drop D immediately following T11;
g) computing a pressure drop B based on A and B;
h) based on A, B, D, IN1, IN2, and a correction factor, issuing a signal indicating that the portal has been opened.

51. A method of detecting opening of a portal in a pressurized room, comprising:
a) obtaining a sequence of barometric pressure for a normally closed room;
b) defining (1) early, (2) middle, and (3) late periods in the sequence;
c) deducing amount of scatter in pressures of both the early and late periods;
d) deducing trending in pressure in the middle period; and
e) based on deductions of paragraphs (b) and (c), issuing a signal indicating that a portal to the room had opened while the sequence was taken.

52. A method of analyzing a sequence of barometric pressure data taken from a normally closed room, comprising:
a) dividing the sequence into (1) early, (2) middle, and (3) late periods;
b) ascertaining early scatter in the early period, and late scatter in the late period;
c) ascertaining a trend in the middle period;
d) based on (i) early scatter, (ii) late scatter, and (iii) inflection weight, issuing a signal indicating that a portal to the room had opened while the sequence was being generated.

53. A method of detecting opening of a portal in a pressurized room, comprising:
a) obtaining a sequence of 21 pressure measurements, N1 through N21, each at a respective time T1 through T21, and all measured within the room at a fixed location remote from the portal;
b) computing pressure drop A between times T10 and T11;
c) computing pressure drop B between times T10 and T12;
d) computing pressure drop D between times T11 and T12;
e) computing standard deviation C of ten pressures T1 through T10;
f) computing standard deviation E of ten pressures T12 through T21;
g) computing SUM = A + B - C - D + E - 0.105; and
h) if SUM is positive, issuing a signal indicating that the portal has been opened between T1 and T10.
